(19) United States
(12) Patent Application Publication
(10) Pub. No.: US 2023/0026408 A1
(43) Pub. Date: Jan. 26, 2023

(54) METHOD FOR PRODUCING AN OPTICAL ELEMENT MADE OF GLASS

(71) Applicant: Docter Optics SE, Neustadt an der Orla (DE)

(72) Inventors: Christoph DITTMANN, Neustadt an der Orla (DE); Alexander KUPPE, Neustadt an der Orla (DE); Annegret DIATTA, Neustadt an der Orla (DE); Ralf POLLE, Neustadt an der Orla (DE)

(73) Assignee: Docter Optics SE, Neustadt an der Orla (DE)

(21) Appl. No.: 17/778,893

(22) PCT Filed: Nov. 27, 2020
(86) PCT No.: PCT/DE2020/101007

§ 371 Date: May 23, 2022

(30) Foreign Application Priority Data
Nov. 28, 2019 (DE) 10 2019 132 406.8
Oct. 20, 2020 (DE) PCT/DE2020/100905

(51) Int. Cl. C03B 11/12; C03C 17/22; C03C 3/078; C03C 3/087; F21S 41/25

(52) U.S. Cl. CPC C03B 11/125; C03C 17/22; C03C 3/078; C03C 3/087; F21S 41/25; C03B 2215/46; C03C 2218/112

(57) ABSTRACT

The disclosure relates to a method for producing an optical element (202), wherein a blank of transparent material is heated and/or provided and, after heating and/or after being provided is press molded, for example on both sides, between a first mold (UF) and at least one second mold (OF), to form the optical element (202) and is then sprayed with a surface treatment agent.

### FIELD OF THE INVENTION

The disclosure relates to a method for producing an optical element, wherein a blank of transparent material is heated and/or provided and, after heating and/or after being provided between a first mold and at least one second mold, is press molded, for example on both sides, to form the optical element.

### BACKGROUND

Such a method is disclosed, for example, in WO 2019/072325 A1 and WO 2019/072326 A1.

In addition to requirements for special contour fidelity and precise optical properties, the desire to press headlight lenses from borosilicate glass or glass systems similar to borosilicate glass has manifested itself in order to achieve increased weather resistance or hydrolytic resistance (chemical resistance). Standards or assessment methods regarding hydrolytic resistance (chemical resistance) are, for example, Hella standard test N67057 and climatic test/humidity frost test. High hydrolytic resistance, for example, is also classified as type 1. In the light of the requirement for borosilicate glass headlight lenses having corresponding hydrolytic resistance, the task arises of pressing headlight lenses from borosilicate glass or similar glass systems with the same hydrolytic resistance (chemical resistance). In departure from this task, an alternative method is proposed for producing an optical element or headlight lens from non-borosilicate glass and/or from soda-lime glass.

U.S. Pat. No. 7,798,688 B2 discloses a projection headlight having a headlight lens and having a light source, wherein a surface intended to face away from the light source of the projection headlight comprises a layer comprising an aluminum concentration that is greater than an aluminum concentration inside the headlight lens.

DE 10 2006 034 431 A1 discloses a process for the surface finishing of alkali-containing glasses, wherein hot surfaces are brought into contact with aluminum chloride compounds from the vapor phase. According to DE 10 2006 034 431 A1, contacting the hot glass surfaces with aluminum chloride dissolved in organic solvent, such as for example methanol, leads to improved surface properties. It is said to be advantageous if the contact of the glass surfaces with aluminum chloride compounds from the vapor phase takes place at lowered oxygen partial pressure. In contrast to treatment from the vapor phase, high amounts of energy could be removed from the glass surface in a short time by aqueous aluminum chloride solutions when they come into contact with a hot glass surface due to the heat of vaporization of the water at the glass surface, with any side effects that occur, such as strength reduction and stress-induced damage to the surface, leading to unacceptable properties. In addition, organic solvents for aluminum chloride such as methanol or ethanol would be ruled out for the skilled person, since their combustion would considerably reduce the oxygen partial pressure, but oxygen would be required for the incorporation of the aluminum into the glass surface. In a departure from this insight, contacting the hot glass surface with aluminum chloride dissolved in organic solvent, such as methanol, would result in improved surface properties.

Compared to the surface treatment described in DE 10 2006 034 431 A1 for bottles with aluminum chloride and its solution in methanol, the teaching of EP 2 043 962 B1 sets out the need for a more durable surface when producing flat glass in a more efficient manner. This need is met in EP 2 043 962 B1 in that, when producing soda-lime-silicate based glass, the glass strip formed from the melt is passed to an annealing lehr, wherein the main surface of the glass strip being applied with aluminum chloride before the annealing lehr at a temperature between 540° C. and 850° C. by applying a mixture of AlCl₃ and at least one solvent to the surface of the glass strip, the mixture comprising 5-10% aluminum chloride and the solvent comprising ethanol.

### SUMMARY

The disclosure relates to a method for producing an optical element or a headlight lens according to the claims, wherein, among other things, it is provided that a blank of non-borosilicate glass and/or of soda-lime glass (soda-lime silicate glass) is heated and/or provided and, after heating and/or after being provided between a first mold, for example for molding and/or for press molding a first optically effective surface of the optical element, and at least one second mold, for example for molding and/or for press molding a second optically effective surface of the optical element, is press molded, for example on both sides, to form the optical element, wherein the first optically effective surface and/or the second optically effective surface (after the molding) is sprayed with a surface treatment agent.

### BRIEF DESCRIPTION OF THE DRAWINGS

FIG. 1 shows a schematic view of a device for manufacturing motor-vehicle headlight lenses or lens-like free-forms for motor-vehicle headlights or optical elements from glass,

FIG. 1A shows a schematic view of a device for manufacturing gobs or optical elements from glass,

FIG. 1B shows a schematic view of a device for manufacturing motor-vehicle headlight lenses or lens-like free-forms for motor-vehicle headlights or optical elements from glass,

FIG. 2A shows an exemplary sequence of a method for manufacturing motor-vehicle headlight lenses or lens-like free-forms for a motor-vehicle headlight or optical elements from glass,

FIG. 2B shows an alternative sequence of a method for manufacturing motor-vehicle headlight lenses or lens-like free-forms for a motor-vehicle headlight or optical elements from glass,

FIG. 3 shows an embodiment of a lance,

FIG. 4 shows another embodiment of a lance,

FIG. 5 shows an exemplary preform before entering a temperature-control apparatus,

FIG. 6 shows an exemplary preform having a reversed temperature gradient after leaving a temperature-control apparatus,

FIG. 7 shows an embodiment of a transport element,

FIG. 8 shows an embodiment of a heating device for a transport element according to FIG. 7,

FIG. 9 shows an embodiment for removing a transport element according to FIG. 7 from a heating device according to FIG. 8,

FIG. 10 shows a headlight lens on a transport element according to FIG. 7,

FIG. 11 shows another embodiment of a transport element,

FIG. 12 shows a cross section through the transport element according to FIG. 11,

FIG. 13 shows a schematic view of an embodiment of a cooling path,

FIG. 14 shows a lance according to FIG. 3 in a hood-type annealing furnace comprising a protective cover for heating a gob,

FIG. 15 shows a view of the hood-type annealing furnace according to FIG. 14 from below,

FIG. 16 shows a cross section through the protective cover according to FIG. 14,

FIG. 17 shows a view into the interior of the protective cover according to FIG. 14,

FIG. 18 shows a perspective view of the protective cover according to FIG. 14,

FIG. 19 shows a cross section through another protective cover,

FIG. 20 shows a view into the interior of the protective cover according to FIG. 19,

FIG. 21 shows a cross section through another protective cover,

FIG. 22 shows a view into the interior of the protective cover according to FIG. 21,

FIG. 23 shows a perspective view of the protective cover according to FIG. 21,

FIG. 24 shows a schematic view of a pressing station for pressing a headlight lens from a heated blank,

FIG. 25 shows another embodiment of a pressing station,

FIG. 26 shows a detail of a pressing station and

FIG. 27 shows a schematic view of a pressing station, modified with respect to the pressing station according to FIG. 24, for pressing a headlight lens from a heated blank,

FIG. 28 shows a view of a detail of the pressing station according to FIG. 27;

FIG. 29 is a schematic view for explaining tilting and radial offset relative to the upper mold,

FIG. 30 shows a schematic view for explaining tilting and radial offset relative to the lower mold,

FIG. 31 shows an embodiment of a decoupling element for torsion,

FIG. 32 shows an embodiment of a modification of the pressing station according to FIGS. 24, 25, 26, 27 and 28 for pressing under vacuum or near vacuum or negative pressure, explained on the basis of a modified representation of the schematic view according to FIG. 24,

FIG. 33 shows a cross-sectional view of an embodiment of a surface-treatment station,

FIG. 34 shows a schematic view of a motor-vehicle headlight (projection headlight) with a headlight lens,

FIG. 35 shows a view of a headlight lens according to FIG. 34 from below,

FIG. 36 shows a cross section of the lens according to FIG. 35,

FIG. 37 shows a detail of the view according to FIG. 36,

FIG. 38 shows the detail according to FIG. 37 with a detail of the transport element (in cross section),

FIG. 39 shows a schematic view of an embodiment of a vehicle headlight according to FIG. 1,

FIG. 40 shows an embodiment of matrix light or adaptive high beam,

FIG. 41 shows another embodiment of matrix light or adaptive high beam,

FIG. 42 shows an embodiment of an illumination device of a vehicle headlight according to FIG. 39,

FIG. 43 shows a side view of an embodiment of a front optics array,

FIG. 44 shows a plan view of the front optics array according to FIG. 43 and,

FIG. 45 shows the use of a front optics array according to FIGS. 43 and 44 in a motor-vehicle headlight,

FIG. 46 shows another embodiment of an alternative vehicle headlight,

FIG. 47 shows another embodiment of an alternative vehicle headlight,

FIG. 48 shows an example of the illumination by means of a headlight according to FIG. 47,

FIG. 49 shows an embodiment of superimposed illumination using the illumination according to FIG. 48 and the illumination by two other headlight systems or sub-systems,

FIG. 50 shows an embodiment of an objective, and

FIG. 51 shows luminous power plotted logarithmically against the distance from a considered point of an object,

FIG. 52 shows a projection display comprising a microlens array having a curved base surface,

FIG. 53 shows a clamping assembly with a flat preform,

FIG. 54 shows a microlens array with a round carrier.

### DETAILED DESCRIPTION

The disclosure relates to a method for producing an optical element or a headlight lens according to the claims, wherein, among other things, it is provided that a blank of non-borosilicate glass and/or of soda-lime glass (soda-lime silicate glass) is heated and/or provided and, after heating and/or after being provided between a first mold, for example for molding and/or for press molding a first optically effective surface of the optical element, and at least one second mold, for example for molding and/or for press molding a second optically effective surface of the optical element, is press molded, for example on both sides, to form the optical element, wherein the first optically effective surface and/or the second optically effective surface (after the molding) is sprayed with a surface treatment agent. Spraying and/or misting in the sense of the present disclosure comprises for example nebulizing, fogging and/or (the use of) spray. Spraying and/or misting within the meaning of the present disclosure particularly means nebulizing, fogging and/or (the use of) spray.

In contrast to the treatment of hollow glass or flat glass disclosed in DE 10 2006 034 431 A1 and EP 2 043 962 B1, the present disclosure relates to the treatment of optically effective surfaces. Here, special requirements apply to cooling, since not only mechanical damage, such as cracks, could lead to unusability, but also internal stresses caused by too rapid cooling. It is therefore all the more surprising that hot optically effective surfaces can be successfully treated in a suitable manner by nebulizing or fogging or by using a spray in order to increase their hydrolytic resistance.

Soda-lime glass within the meaning of this disclosure comprises for example

60 to 75 wt. % SiO₂ and

3 to 12 wt. % CaO,

or

70 to 75 wt. % SiO₂ and

3 to 12 wt. % CaO.

Soda-lime glass within the meaning of this disclosure comprises for example

60 to 75 wt. % SiO₂,

3 to 12 wt. % K₂O and

3 to 12 wt. % CaO,

or

70 to 75 wt. % SiO₂,

3 to 12 wt. % K₂O and

3 to 12 wt. % CaO.

Soda-lime glass within the meaning of this disclosure comprises for example

60 to 75 wt. % SiO₂,

3 to 12 -wt. % Na₂O,

3 to 12 wt. % K₂O and

3 to 12 wt. % CaO,

or

70 to 75 wt. % SiO₂,

3 to 12 wt. % Na₂O,

3 to 12 wt. % K₂O and

3 to 12 wt. % CaO.

Soda-lime glass within the meaning of this disclosure comprises for example

0.2 to 2 wt. % Al₂O₃,

60 to 75 wt. % SiO₂,

3 to 12 wt. % Na₂O,

3 to 12 wt. % K₂O and

3 to 12 wt. % CaO,

Soda-lime glass within the meaning of this disclosure comprises for example

0.2 to 2 wt. % Al₂O₃,

0.1 to 1 wt. % Li₂O,

60 to 75 wt. % SiO₂,

3 to 12 wt. % Na₂O,

3 to 12 wt. % K₂O and

3 to 12 wt. % CaO,

or

0.2 to 2 wt. % Al₂O₃,

0.1 to 1 wt. % Li₂O,

70 to 75 wt. % SiO₂,

3 to 12 wt. % Na₂O,

3 to 12 wt. % K₂O and

3 to 12 wt. % CaO,

Soda-lime glass within the meaning of this disclosure comprises for example

0.2 to 2 wt. % Al₂O₃,

0.1 to 1 wt. % Li₂O,

0.3, for example 0.4, to 1.5 wt. % Sb₂O₃,

60 to 75 wt. % SiO₂,

3 to 12 wt. % Na₂O,

3 to 12 wt. % K₂O and

3 to 12 wt. % CaO,

such as DOCTAN®, or

0.2 to 2 wt. % Al₂O₃,

0.1 to 1 wt. % Li₂O,

0.3, for example 0.4, to 1.5 wt. % Sb₂O₃,

70 to 75 wt. % SiO₂,

3 to 12 wt. % Na₂O,

3 to 12 wt. % K₂O and

3 to 12 wt. % CaO.

It may be provided that at least one optically effective surface is fire-polished before the treatment with surface treatment agent. In one embodiment it is for example provided that only the underside is fire-polished. This is provided for example in connection with a configuration of the lower optically effective surface as a planar surface. It has been found suitable, when fire polishing is provided, a waiting time to be allowed to elapse before the surface is exposed to the surface treatment agent. The waiting time is for example at least two seconds, for example at least three seconds, for example at least four seconds. In an embodiment, the fire polishing takes no longer than three seconds, for example no longer than two seconds. Waiting times or holding times can be at least 20 s, for example, but for example no more than 50 s, for example for large lenses.

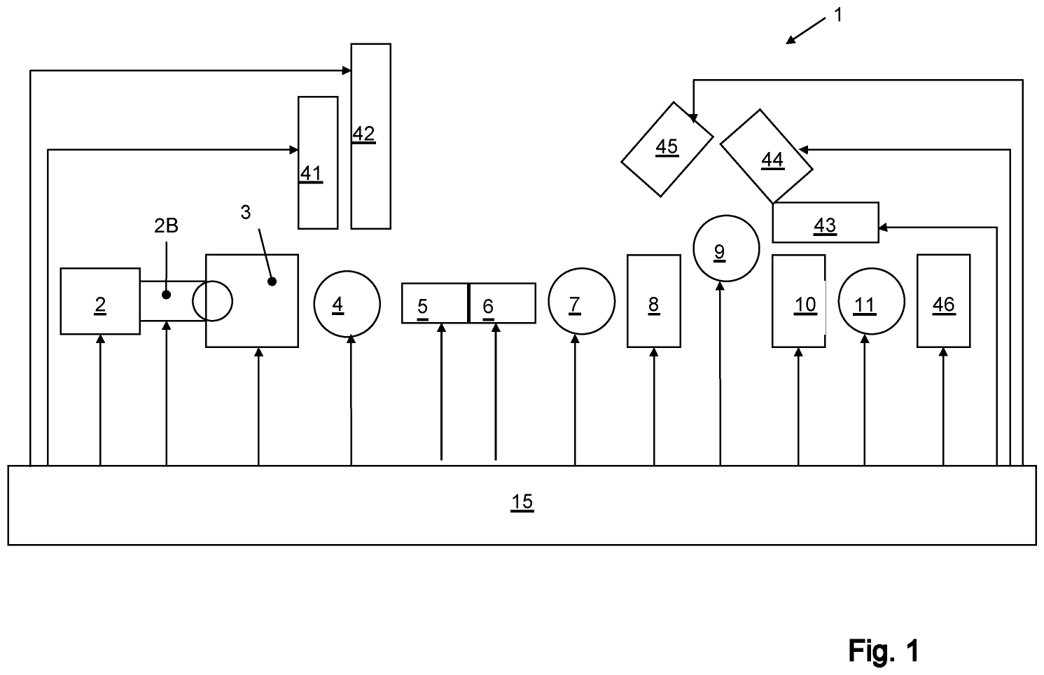

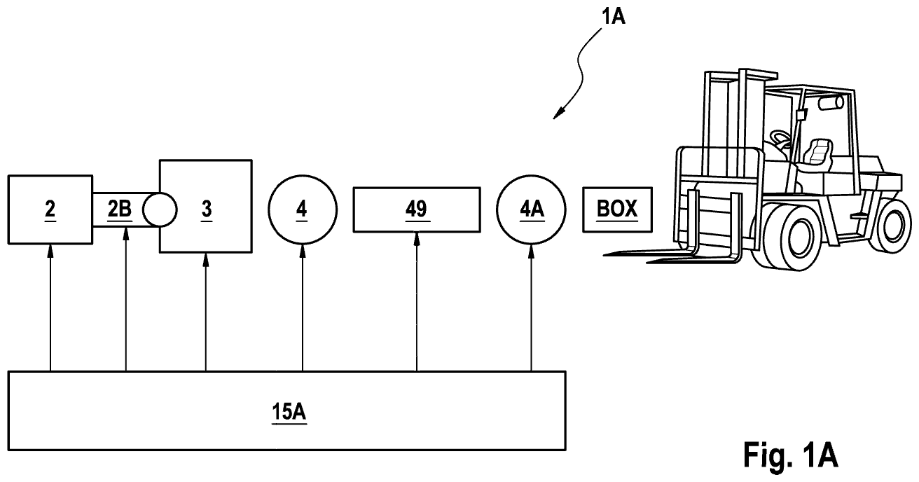

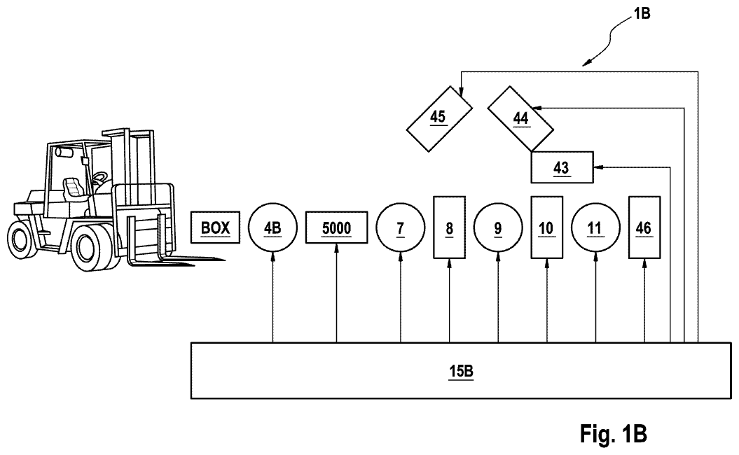

Surface treatment agent within the meaning of this disclosure comprises for example AlCl₃, for example AlCl₃*6H₂O (dissolved in solvent and/or H₂O), suitable mixing ratios being taken from DE 103 19 708 A1 (e.g. FIG. 1). For example, at least 0.5 g, for example at least 1 g AlCl₃*6H₂O per liter H₂O are provided. The surface treatment agent within the meaning of the present disclosure for example comprises an active portion dissolved in a solvent, wherein the solvent may be a complementary active portion. The solvent may be, for example, water, but an alcohol may also be considered, or a surface treatment agent comprising different alcohols, or a surface treatment agent comprising one or more of these alcohols and water. Appropriate alcohols may be, for example, methanol, ethanol or isopropanol. For example, the proportion of alcohol may be 2 to 38%, for example up to 25%, of the solvent, the other essential component of which is water. The active ingredient may comprise or be, for example, hydrous aluminum chloride, i.e. AlCl₃*6H₂O, aluminum, aluminum powder with a grain size of ≥100 μm, aluminum powder with a grain size of ≥85 μm, aluminum powder with a grain size of ≥65 μm, phosphate, potassium phosphate, and/or sodium phosphate (compare also DE 10 2012 019 985 B4).

According to one embodiment, the surface treatment agent comprises, based on the total mass of the surface treatment agent, 25 to 65% by weight (for example 35 to 55% by weight) of water, 30 to 70% by weight (for example 40 to 60% by weight) of potassium phosphate, 1 to 8% by weight (for example 2 to 6% by weight) of sodium phosphate and 0.001 to 0.010% by weight (for example 0.002 to 0.006% by weight) of aluminum, the constituents adding up to no more than 100%. In another embodiment, the surface treatment agent comprises 35 to 65% by weight or 25 to 55% by weight water, based on the total mass of the surface treatment agent. According to another embodiment, the surface treatment agent comprises 40 to 70% by weight or 30 to 60% by weight potassium phosphate. According to another embodiment, the surface treatment agent comprises 2 to 8% by weight or 1 to 6% by weight sodium phosphate. According to another embodiment, the surface treatment agent comprises 0.002 to 0.010% by weight or 0.001 to 0.006% by weight aluminum.

In an embodiment, the first optically effective surface and the second optically effective surface are sprayed with the surface treatment agent at least partially simultaneously (overlapping in time).

In an embodiment, the temperature of the optical element and/or the temperature of the first optically effective surface and/or the temperature of the second optically effective surface when sprayed with surface treatment agent is not less than T_{G} or T_{G}+20K, where T_{G} denotes the glass transition temperature.

In an embodiment, the temperature of the optical element and/or the temperature of the first optically effective surface and/or the temperature of the second optically effective surface when sprayed with surface treatment agent is not greater than T_{G}+100K. In contrast to the high temperatures described in EP 2 043 962 B1, the good piece yield could be improved at lower temperatures below T_{G}+100K (but above T_{G}), so that this temperature range is particularly suitable for surface treatment in the aforementioned sense in the context of industrial production.

In an embodiment, the surface treatment agent is sprayed onto the optically effective surface as a spray agent, wherein the surface treatment agent forms droplets whose size and/or whose average size and/or whose diameter and/or whose average diameter is not greater than 50 μm.

In an embodiment, the surface treatment agent is sprayed onto the optically effective surface as a spray agent, wherein the surface treatment agent forms droplets whose size and/or whose average size and/or whose diameter and/or whose average diameter is not smaller than 10 μm.

In an embodiment, the surface treatment agent sprayed is mixed with compressed air. In an embodiment, compressed air is used to generate a spray for the surface treatment agent, for example in conjunction with a mixing nozzle or a two-substance nozzle. In an embodiment, the surface treatment agent is sprayed mixed with gas. In an embodiment, a gas or gas mixture (for example in connection with a pressure of at least two bar), for example in connection with a mixing nozzle or a two-substance nozzle, is used to generate a spray for the surface treatment agent. For example, the gas is mixed with the surface treatment agent under pressure (e.g. at least two bar or at least three bar). For example, the gas is mixed with the gas (immediately) prior to impingement on the optically effective surface. In one embodiment, the gas may be or comprise nitrogen and/or carbon dioxide.

In an embodiment, spraying of the optically effective surface with the surface treatment agent is carried out prior to cooling of the optical element in a cooling path for cooling in accordance with a cooling regime.

For example, it is provided that residues from the surface treatment process are removed, for example washed away. This may for example be carried out using water, without the addition of cleaning agents. The optical elements may have a (white) precipitate, for example the reaction product, after treatment with the surface treatment agent. For example, VE-water can be used to clean the optical elements. VE water is demineralized water. The abbreviation VE stands for “vollentsalzt (fully demineralized)”. Cleaning can be carried out, for example, at a water temperature of 60° C. of the VE-water. There is no need to use a detergent such as CEROWEG, which is known from WO 2019 243 343 A1.

For example, it is envisaged that the optical element or lens has a transmission of greater than 90% after washing and/or removal of residues from the surface treatment process.

In an embodiment, an optically effective surface is sprayed with the surface treatment agent for no longer than 4 seconds. For example, an optically effective surface is sprayed with the surface treatment agent for no longer than 3 seconds, for example no longer than 2 seconds, for example no longer than one second. For example, spraying is carried out until the optically effective surface is sprayed with no less than 0.05 ml of surface treatment agent and/or with no more than 0.5 ml, for example 0.2 ml of surface treatment agent.

It is for example provided that the headlight lens or a headlight lens according to the disclosure on the surface after being sprayed with surface-treatment agent consists of at least 90%, for example at least 95%, for example (substantially) 100%, of quartz glass, produced by crosslinking of oxygen ions with silicon ions on the optically effective surface. It is for example provided that the amount of crosslinking of oxygen ions to silicon ions on the optically active surface of the headlight lens or the optical element after the spraying can be represented by the relationship

$$\frac{Q ( 4 )}{Q ( 4 ) + Q ( 3 )} \geq 0 , 9$$

and in further example, can be represented by the relationship

$$\frac{Q ( 4 )}{Q ( 4 ) + Q ( 3 )} \geq 0 , 95$$

In the above, Q(3) denotes 3 oxygen ions crosslinking at tetrahedron corners of a silicon ion and Q(4) denotes 4 oxygen ions crosslinking at tetrahedron corners of a silicon ion. The proportion of quartz glass decreases from the optically effective surface towards the interior of the headlight lens or optical element, wherein, at a depth (distance from the surface) of 5 μm, it is for example provided that the proportion of quartz glass is at least 10%, for example at least 5%. It is for example provided that the amount of the crosslinking of oxygen ions to silicon ions at a depth of 5 μm below the optically effective surface of the headlight lens or the optical element can be represented by the relationship:

$$\frac{Q ( 4 )}{Q ( 4 ) + Q ( 3 )} \geq 0 , 1$$

and in further example, can be represented by the relationship:

$$\frac{Q ( 4 )}{Q ( 4 ) + Q ( 3 )} \geq 0 , 05$$

It is for example provided that the proportion of quartz glass at a depth (distance from the surface) of 5 μm is no greater than 50%, for example no greater than 25%. It is for example provided that the amount of the crosslinking of oxygen ions to silicon ions at a depth of 5 μm below the optically effective surface of the headlight lens or the optical element after the spraying can be represented by the relationship:

$$\frac{Q ( 4 )}{Q ( 4 ) + Q ( 3 )} \leq 0 , 5$$

and in further example, can be represented by the relationship:

$$\frac{Q ( 4 )}{Q ( 4 ) + Q ( 3 )} \leq 0 , 25$$

It may be provided that (in addition) the concentration of sodium ions in the interior of the lens is higher than in the near-surface region. Near-surface in the sense of the present disclosure may for example mean a depth of no greater than 5 μm. It may be provided that (in addition) the concentration of aluminum ions is lower inside the lens than in the near-surface region. It may be provided that during the treatment with surface treatment agent, ion exchange between ions in the glass or its near-surface region and the surface treatment agent occurs to some extent.

In an embodiment the first mold is moved by means of an actuator for moving the first mold by the first mold and the actuator being connected by means of a first movable guide rod and at least one second movable guide rod, for example at least one third movable guide rod, wherein the first movable guide rod is guided in a recess of a fixed guide element and the second movable guide rod is guided in a recess of the fixed guide element and the optional third movable guide rod is guided in a recess of the fixed guide element, wherein it is for example provided that the deviation of the position of the mold orthogonally to the movement direction of the mold from the target position of the mold orthogonally to the movement direction of the mold is no greater than 20 μm, for example no greater than 15 μm, for example no greater than 10 μm.

In an embodiment, the at least second mold is moved by means of an actuator for moving the second mold in a frame, which comprises a first fixed guide rod, at least one second fixed guide rod and, for example, at least one third fixed guide rod, wherein the first fixed guide rod, the at least second fixed guide rod and the optional at least third fixed guide rod are connected at one end by an actuator-side fixed connector and at the other end by a mold-side fixed connector, wherein the at least second mold is fixed to a movable guide element which comprises a recess through which the first fixed guide rod is guided, a further recess through which the at least second fixed guide rod is guided and optionally a further recess through which the optional third fixed guide rod is guided, wherein it is for example provided that the deviation in the position of the mold orthogonally to the movement direction of the mold from the target position of the mold orthogonally to the movement direction of the mold is no greater than 20 μm, for example no greater than 15 μm, for example no greater than 10 μm.

In an embodiment, it is for example provided that the first mold is moved by means of an actuator for moving the first mold in that the first mold and the actuator for moving the first mold being connected by means of a first movable guide rod and at least one second movable guide rod, for example at least one third movable guide rod, wherein the first movable guide rod being guided in a recess of a fixed guide element, the second movable guide rod being guided in a recess of the fixed guide element, and the optional third movable guide rod being guided in a recess of the fixed guide element.

In an embodiment it is provided that the fixed guide element is identical to the mold-side fixed connector, or is indirectly or directly fixed thereto.

In an embodiment the first mold is a lower mold and/or the second mold is an upper mold.

In an embodiment it is provided that, before pressing, the blank is placed on an annular or free-form support surface of a carrier body having a hollow cross section, and is heated on the carrier body, for example such that a temperature gradient is established such that the blank is cooler in its interior than on its outer region. It is for example provided that the support surface is cooled by means of a cooling medium flowing through the carrier body, wherein it is for example provided that the support surface spans a base surface which is not circular. In this case, a geometry of the support surface or a geometry of the base surface of the support surface is for example provided which corresponds to the geometry of the blank (which is to be heated), wherein the geometry is selected such that the blank rests on the outer region of its underside (underside base surface). The diameter of the underside side or the underside base surface of the blank is at least 1 mm greater than the diameter of the base surface spanned (by the carrier body or its support surface). In this sense, it is for example provided that the geometry of the surface of the blank facing the carrier body corresponds to the support surface or the base surface. This for example means that, after the forming process or press molding, the part of the blank resting on the carrier body or contacting the carrier body during heating is arranged in an edge region of the headlight lens which lies outside the optical path and which rests for example on a transport element (see further below) or its (corresponding) support surface.

An annular support surface may comprise small discontinuities. Within the meaning of this disclosure, a base surface is for example an imaginary surface (in the region of which the blank resting on the carrier body is not in contact with the carrier body), which lies in the plane of the support surface and is surrounded by this support surface, plus the support surface. It is for example provided that the blank and the carrier body are coordinated with one another. This is for example understood to mean that the edge region of the blank rests on the carrier body on its underside. An edge region of a blank can be understood to mean the outer 10% or the outer 5% of the blank or its underside, for example.

In the sense of the disclosure, a blank is for example a portioned glass part or a preform or a gob.

An optical element in the sense of the disclosure is for example a lens, for example a headlight lens or a lens-like freeform. An optical element in the sense of the disclosure is, for example, a lens or a lens-like free-form comprising a, for example, circumferential, interrupted or interrupted circumferential supporting edge. An optical element in the sense of the disclosure may be, for example, an optical element as described, for example, in WO 2017/059945 A1, WO 2014/114309 A1, WO 2014/114308 A1, WO 2014/114307 A1, WO 2014/072003 A1, WO 201 3/1 7831 1 A1, WO 2013/170923 A1, WO 2013/159847 A1, WO 2013/123954 A1, WO 2013/135259 A1, WO 2013/068063 A1, WO 2013/068053 A1, WO 2012/130352 A1, WO 2012/072187 A2, WO 2012/072188 A1, WO 2012/072189 A2, WO 2012/072190 A2, WO 2012/072191 A2, WO 2012/072192 A1, WO 2012/072193 A2, PCT/EP2017/000444. Each of these documents is incorporated by reference in its entirety. The claimed method is for example applicable to non-symmetrical headlight lenses or to non-rotationally symmetrical headlight lenses. For example, the claimed method is applicable to headlight lenses with non-symmetrical contours or non-rotationally symmetrical contours. For example, the claimed method is applied to headlight lenses with deterministic surface structures, such as disclosed in WO 2015/031925 A1, and for example with deterministic non-periodic surface structures, such as disclosed in DE 10 2011 114 636 A1.

In an embodiment, the base surface is polygon-shaped or polygonal, but for example with rounded corners, wherein it is for example provided that the underside base surface of the blank is also polygon-shaped or polygonal, but for example with rounded corners. In an embodiment, the base surface is triangle-shaped or triangular, but for example with rounded corners, wherein it is for example provided, that the underside base surface of the blank is also triangle-shaped or triangular, but for example with rounded corners. In an embodiment, the base surface is rectangle-shaped or rectangular, but for example with rounded corners, wherein it is for example provided that the underside base surface of the blank is also rectangle-shaped or rectangular, but for example with rounded corners. In an embodiment, the base surface is square, but for example with rounded corners, wherein it is for example provided that the underside base surface of the blank is also square, but for example with rounded corners. In an embodiment, the base surface is oval, wherein it is for example provided that the underside base surface of the blank is also oval.

In an embodiment, the carrier body is tubular at least in the region of the support surface. The carrier body consists (at least substantially), for example, of steel or high-alloy steel (i.e., for example, a steel in which the average mass content of at least one alloy element is 5%) or of a tube of steel or high-alloy steel. In an embodiment, the diameter of the hollow cross-section of the carrier body or the internal tube diameter, at least in the region of the support surface, is no less than 0.5 mm and/or is no greater than 1 mm. In an embodiment, the external diameter of the carrier body or the external tube diameter, at least in the region of the support surface, is no less than 2 mm and/or no greater than 4 mm, for example no greater than 3 mm. In an embodiment, the radius of curvature of the support surface orthogonally to the flow direction of the coolant is no less than 1 mm and/or no greater than 2 mm, for example no greater than 1.5 mm. In an embodiment, the ratio of the diameter of the hollow cross-section of the carrier body at least in the region of the support surface to the external diameter of the carrier body at least in the region of the support surface is no less than ¼ and/or no greater than ½. In an embodiment, the carrier body is uncoated at least in the region of the support surface. In an embodiment, coolant flows through the carrier body in accordance with the counterflow principle. In an embodiment, the coolant is additionally or actively heated. In an embodiment, the carrier body comprises at least two flow channels for the coolant flowing therethrough, which each only extends over a section of the annular support surface, wherein it is for example provided that two flow channels are connected in a region in which they leave the support surface by means of metallic filler material, for example solder.

In a further embodiment it is provided that, after press molding, the optical element is placed on a transport element, is sprayed with surface-treatment agent on the transport element and, thereafter or subsequently, passes through a cooling path on the transport element without an optical surface of the optical element being touched. In the sense of the disclosure, a cooling path is for example used for the controlled cooling of the optical element (for example with the addition of heat). Exemplary cooling regimes may e.g. be found in “Werkstoffkunde Glas” [Glass Materials Science], 1^{st} edition, VEB Deutscher Verlag für Grundstoffindustrie, Leipzig VLN 152-915/55/75, LSV 3014, editorial deadline: 1.9.1974, order number: 54107, e.g. page 130 and “Glastechnik—BG 1/1—Werkstoff Glas” [Glass Technology—vol. 1/1—Glass: The Material], VEB Deutscher Verlag für Grundstoffindustrie, Leipzig 1972, e.g. page 61 ff (incorporated by reference in its entirety). It is necessary to comply with a cooling regime of this kind in order to prevent any internal stresses within the optical element or the headlight lens, which, although they are not visible upon visual inspection, can sometimes significantly impair the lighting properties as an optical element of a headlight lens. These impairments result in a corresponding optical element or headlight lens becoming unusable. It has surprisingly been found that, although according to the disclosure spraying the hot optical element or headlight lens after press molding or after removal from the mold following the press molding changes the cooling regime, the resulting optical stresses are negligible. It is also surprising that a corresponding headlight lens ranges between the above-mentioned optical tolerances in relation to its optical property, although the refractive index is reduced by the proportion of quartz glass on the surface.

In an embodiment, the transport element is made of steel. For clarification, the transport element is not part of the lens (or headlight lens), or the lens (or headlight lens) and the transport element are not part of a common one-piece body.

In an embodiment, the transport element is heated, for example inductively, before receiving the optical element. In an embodiment, the transport element is heated at a heating rate of at least 20 K/s, for example at least 30 K/s. In an embodiment, the transport element is heated at a heating rate of no greater than 50 K/s. In an embodiment, the transport element is heated by a current-carrying winding/coil winding which is arranged above the transport element.

In an embodiment, the optical element comprises a support surface which lies outside the intended light path for the optical element, wherein the support surface, for example only the support surface, is in contact with a corresponding support surface of the transport element when the optical element is placed on the transport element. In an embodiment, the support surface of the optical element is located at the edge of the optical element. In an embodiment, the transport element comprises at least one limiting surface for aligning the optical element on the transport element or for limiting or preventing movement of the optical element on the transport element. In one embodiment, the limiting surface or limiting surfaces are provided above the corresponding support surface of the transport element. In a further embodiment, (at least) two limiting surfaces are provided, wherein it may be provided that one limiting surface is below the corresponding support surface of the transport element and one limiting surface is above the corresponding support surface of the transport element. In an embodiment, the transport element is adapted, manufactured, for example milled, to the optical element or to the support surface of the optical element.

The transport element or the support surface of the transport element is for example annular but for example not circular.

In an embodiment, the preform is produced, cast and/or molded from molten glass. In an embodiment, the mass of the preform is 20 g to 400 g.

In an embodiment, the temperature gradient of the preform is set such that the temperature of the core of the preform is above 10K+T_{G}.

In an embodiment to reverse its temperature gradient, the preform is first cooled, for example with the addition of heat, and then heated, wherein it is for example provided that the preform is heated such that the temperature of the surface of the preform after heating is at least 100 K, for example at least 150 K, higher than the glass transition temperature T_{G}. The glass transition temperature T_{G} is the temperature at which the glass becomes hard. Within the sense of this disclosure, the glass transition temperature T_{G} is for example intended to be the temperature of the glass at which it has a viscosity log in a range around 13.2 (corresponding to 10^{13.2} Pas), for example between 13 (corresponding to 10¹³ Pas) and 14.5 (corresponding to 10^{14.5} Pas). In relation to the glass type B270, the transition temperature T_{G} is approximately 530° C.

In an embodiment, the temperature gradient of the preform is set such that the temperature of the upper surface of the preform is at least 30K, for example at least 50K, above the temperature of the lower surface of the preform. In an embodiment, the temperature gradient of the preform is set such that the temperature of the core of the preform is at least 50K below the temperature of the surface of the preform. In an embodiment, the preform is cooled such that the temperature of the preform before heating is T_{G}-80K to T_{G}+30K. In an embodiment, the temperature gradient of the preform is set such that the temperature of the core of the preform is 450° C. to 550° C. The temperature gradient may be set such that the temperature of the core of the preform is below T_{G} or near T_{G} . In an embodiment, the temperature gradient of the preform is adjusted such that the temperature of the surface of the preform is 700° C. to 900° C., for example 750° C. to 850° C. In an embodiment, the preform is heated in such a way that its surface (for example immediately before pressing) assumes a temperature corresponding to the temperature at which the glass of the preform has a viscosity log between 5 (corresponding to 10⁵ Pas) and 8 (corresponding to 10⁸ Pas), for example a viscosity log between 5.5 (corresponding to 10^{5.5} Pas) and 7 (corresponding to 10⁷ Pas).

For example, it is provided that the preform is removed from a mold for forming or producing the preform before the temperature gradient is reversed. It is for example provided that the reversal of the temperature gradient takes place outside a mold. For the purposes of the disclosure, cooling with the addition of heat is intended to mean for example that cooling is carried out at a temperature of more than 100° C.

For the purposes of the disclosure, the term “press molding” is to be understood for example as pressing a (particularly optically effective) surface in such a way that subsequent finishing of the contour of this (particularly optically effective) surface can be omitted or is omitted or is not provided for. It is thus particularly intended that a press molded surface is not ground after the press molding. Polishing, which does not affect the contour of the surface but the surface finish of the surface, may be provided. By press molding on both sides it is to be understood for example that a (for example optically effective) light exit area is press molded and a (for example optically effective) light entrance area for example opposite the (for example optically effective) light exit area is also press molded.

In one embodiment, the blank is placed on an annular support surface of a carrier body with a hollow cross section and is heated on the carrier body, for example in such a way that a temperature gradient is set in the blank in such a way that the blank is cooler in the interior than in its outer region, the support surface being cooled by means of a cooling medium flowing through the carrier body, wherein the blank of glass is press molded after heating to the optical element, for example on both sides, wherein the carrier body comprises at least two flow channels for the cooling medium flowing through, each extending only over a portion of the annular support surface, and wherein two flow channels are connected with metallic filler material, for example solder, in a region in which they leave the support surface.

A guide rod as defined in the present disclosure may be a rod, tube, profile, or the like.

Fixed in the sense of this disclosure means for example directly or indirectly fixed to a foundation of the pressing station or the press or a base on which the pressing station or the press stands. Two elements in the sense of this disclosure are fixed to each other for example if for pressing it is not intended that they are moved relative to each other.

For pressing, the first and the second mold are for example moved towards each other in such a way that they form a closed mold or cavity or a substantially closed mold or cavity. Moving towards each other in the sense of this disclosure means for example that both molds are moved. However, it can also mean that only one of the two molds is moved.

A recess in the sense of the disclosure comprises for example a bearing which couples or connects the recess with the corresponding guide rod. A recess in the sense of the present disclosure can be extended to a sleeve or be designed as a sleeve. A recess in the sense of the present disclosure can be extended to a sleeve with an inner bearing or can be designed as a sleeve with an inner bearing.

In a matrix headlight, the optical element or a corresponding headlight lens is used, for example, as a secondary lens for imaging a front optics. A front optics in the sense of this disclosure is arranged for example between the secondary optics and a light source arrangement. A front optics in the sense of the present disclosure is for example arranged in the light path between the secondary optics and the light source assembly. A front optics in the sense of this disclosure is for example an optical component for shaping a light distribution depending on light that is generated by the light source assembly and is directed therefrom into the front optics. Here, a light distribution is generated or formed, for example, by TIR, i.e., by total reflection.

The optical element according to the disclosure or a corresponding lens is also used, for example, in a projection headlight. In the configuration as a headlight lens for a projection headlight, the optical element or a corresponding headlight lens forms the edge of a shield in the form of a bright-dark-boundary on the road.

Motor vehicle in the sense of the disclosure is for example a land vehicle which can be used individually in road traffic. Motor vehicles within the meaning of the disclosure are for example not limited to land vehicles with internal combustion engines.

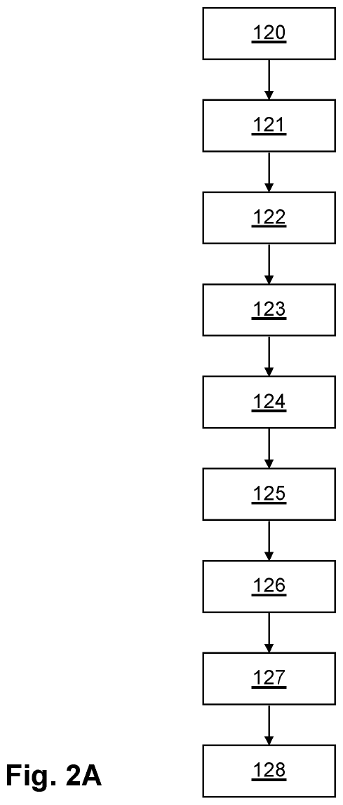

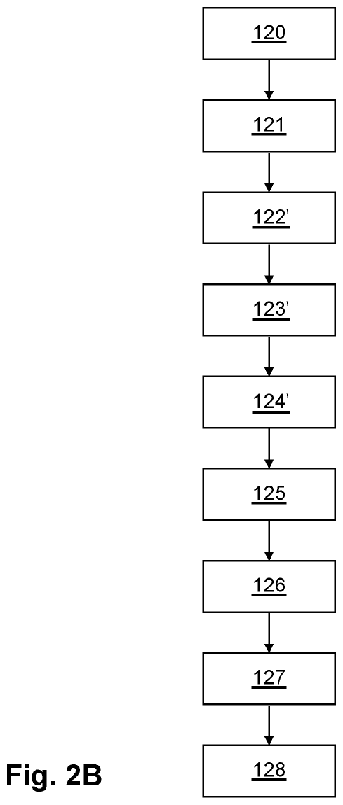

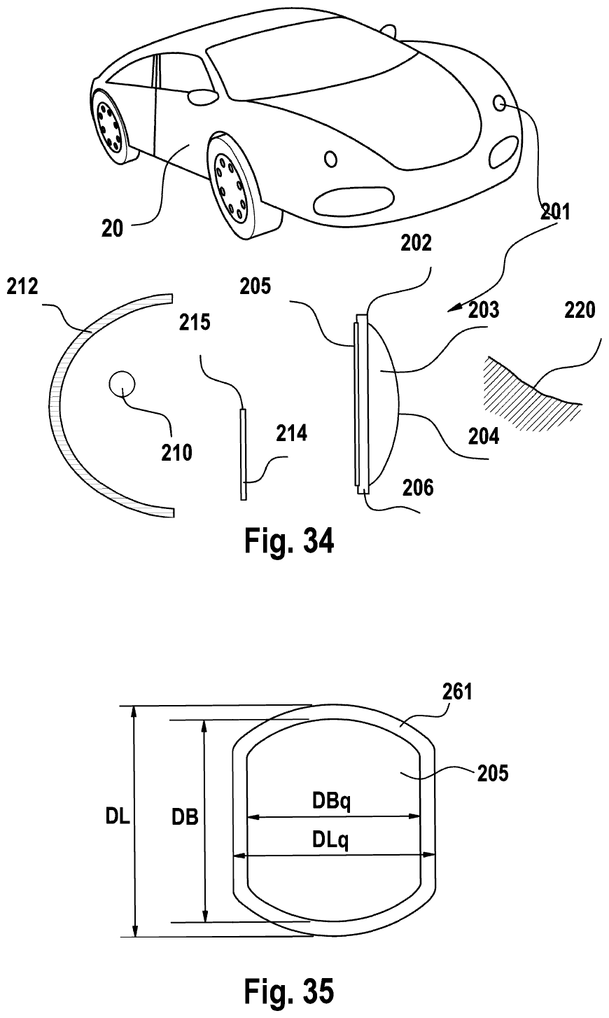

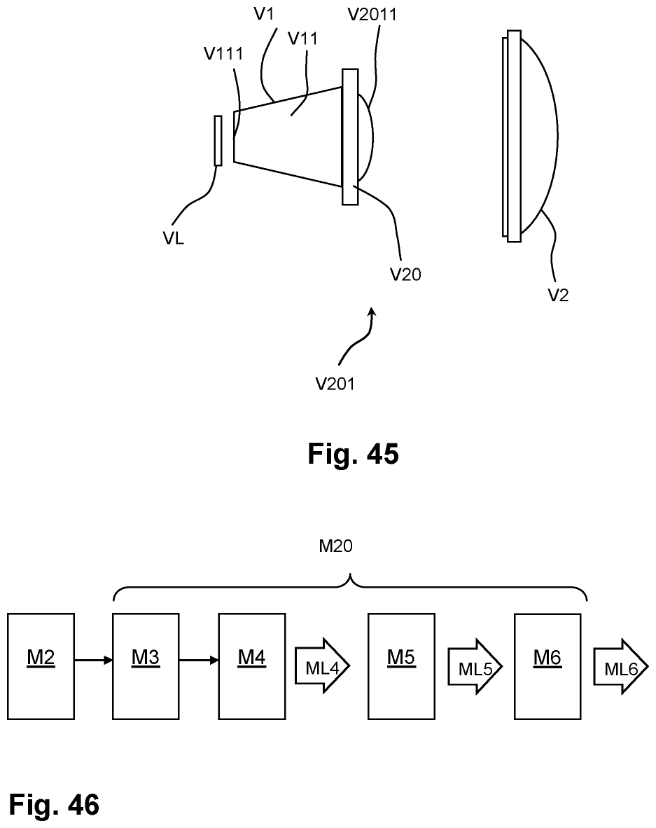

FIG. 1 as well as FIG. 1A and FIG. 1B show a schematically shown device 1 or 1A and 1B for carrying out a method shown in FIG. 2A or FIG. 2B for producing optical elements, for example such as optical lenses, such as motor vehicle headlight lenses, for example such as the (motor vehicle) headlight lens 202 shown schematically in FIG. 34, or (lens-like) free-forms, for example for motor-vehicle headlights, for example their use as described below with reference to FIG. 45.

FIG. 34 is a schematic view of a motor-vehicle headlight 201 (projection headlight) of a motor vehicle 20, comprising a light source 210 for generating light, a reflector 212 for reflecting light that can be generated by means of the light source 210, and a shield 214. The motor-vehicle headlight 201 also comprises a headlight lens 202 for imaging an edge 215 of the shield 214 as a bright-dark-boundary 220 by means of light that can be generated by the light source 210. Typical requirements placed on the bright-dark-boundary or on the light distribution taking into account or incorporating the bright-dark-boundary are disclosed e.g. in Bosch—Automotive Handbook, 9^{th} edition, ISBN 978-1-119-03294-6, page 1040. Within the meaning of this disclosure, a headlight lens is e.g. a headlight lens by means of which a bright-dark-boundary can be generated, and/or a headlight lens by means of which the requirements according to Bosch—Automotive Handbook, 9^{th} edition, ISBN 978-1-119-03294-6 (incorporated by reference in its entirety), page 1040, can be met. The headlight lens 202 comprises a lens body 203 made of glass, which has a substantially planar (for example optically effective) surface 205 facing the light source 210 and a substantially convex (for example optically effective) surface 204 facing away from the light source 210. The headlight lens 202 also comprises a (for example circumferential) edge 206, by means of which the headlight lens 202 may be fastened in the motor-vehicle headlight 201. The elements in FIG. 34 are not necessarily shown to scale for the sake of simplicity and clarity. Therefore, for example, the scales of some elements are exaggerated compared with other elements in order to improve the understanding of the embodiment of the present disclosure.

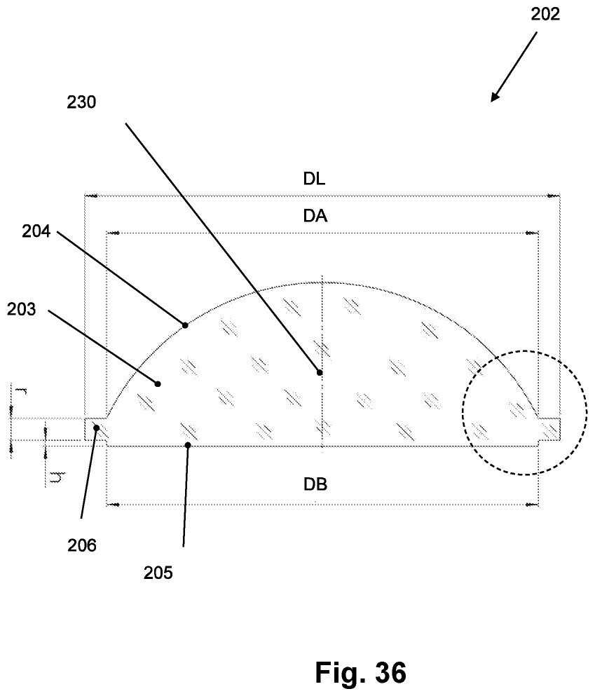

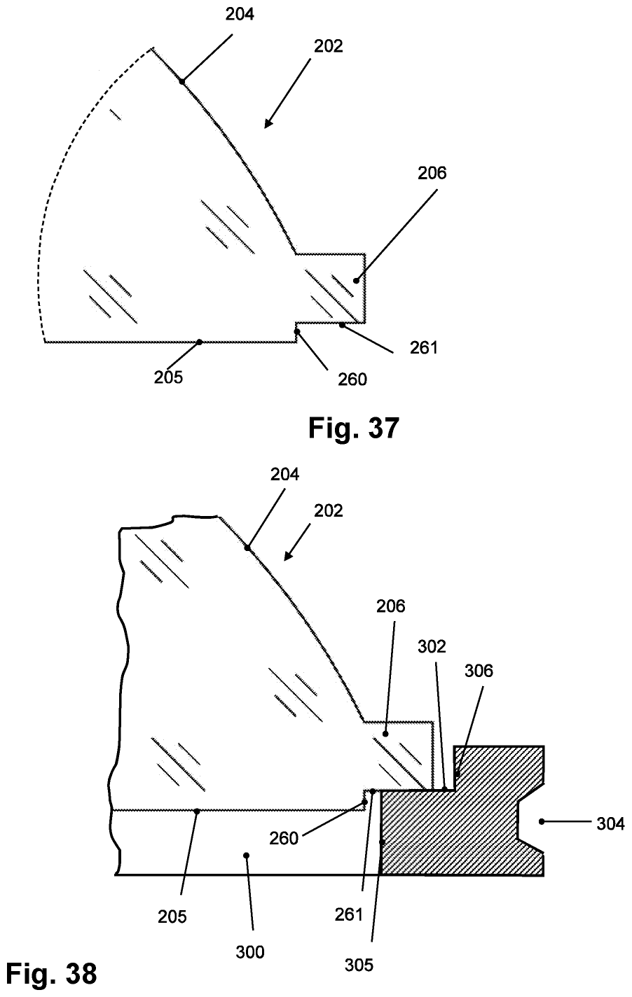

FIG. 35 is a view of the headlight lens 202 from below. FIG. 36 is a cross section through an embodiment of the headlight lens. FIG. 37 shows a detail of the headlight lens 202 marked by a dashed circle in FIG. 36. The planar (for example optically effective) surface 205 projects in the form of a step 260 towards the optical axis 230 of the headlight lens 202 beyond the lens edge 206 or beyond the surface 261 of the lens edge 206 facing the light source 210, wherein the height h of the step 260 is e.g. no greater than 1 mm, for example no greater than 0.5 mm. The nominal value of the height h of the step 260 is for example 0.2 mm.

The thickness r of the lens edge 206 according to FIG. 36 is at least 2 mm, but no greater than 5 mm. According to FIGS. 35 and 36, the diameter DL of the headlight lens 202 is at least 40 mm, but no greater than 100 mm. The diameter DB of the substantially planar (for example optically effective) surface 205 is equal to the diameter DA of the convex curved optically effective surface 204. In one configuration, the diameter DB of the substantially planar optically effective surface 205 is no greater than 110% of the diameter DA of the convex curved optically effective surface 204. In addition, the diameter DB of the substantially planar optically effective surface 205 is for example at least 90% of the diameter DA of the convex curved optically effective surface 204. The diameter DL of the headlight lens 202 is for example approximately 5 mm greater than the diameter DB of the substantially planar optically effective surface 205 or than the diameter DA of the convex curved optically effective surface 204. The diameter DLq of the headlight lens 202 extending orthogonally to DL is at least 40 mm, but no greater than 80 mm, and is less than the diameter DL. The diameter DLq of the headlight lens 202 is for example approximately 5 mm greater than the diameter DBq that is orthogonal to DB.

In an embodiment, the (optically effective) surface 204 to be turned away from the light source and/or the (optically effective) surface 205 to be turned toward the light source has a light-scattering surface structure (produced/pressed by molding). A suitable light-scattering surface structure comprises, for example, a modulation and/or a (surface) roughness of at least 0.05 μm, for example at least 0.08μ or is designed as a modulation optionally with an additional (surface) roughness of at least 0.05 μm, for example at least 0.08μ. Roughness in the sense of the disclosure is to be defined for example as Ra, for example according to ISO 4287. In an embodiment, the light-scattering surface structure may comprise a structure mimicking a golf ball surface or be configured as a structure mimicking a golf ball surface. Suitable light scattering surface structures are disclosed, for example, in DE 10 2005 009 556 A1, DE 102 26 471 B4 and DE 299 14 114 U1. Further embodiments of light scattering surface structures are disclosed in German patent specification 1 099 964, DE 36 02 262 C2, DE 40 31 352 A1, U.S. Pat. No. 6,130,777 A, US 2001/0033726 A1, JP 10123307 A, JP 09159810 A, DE 11 2018 000 084 A5 and JP 01147403 A.

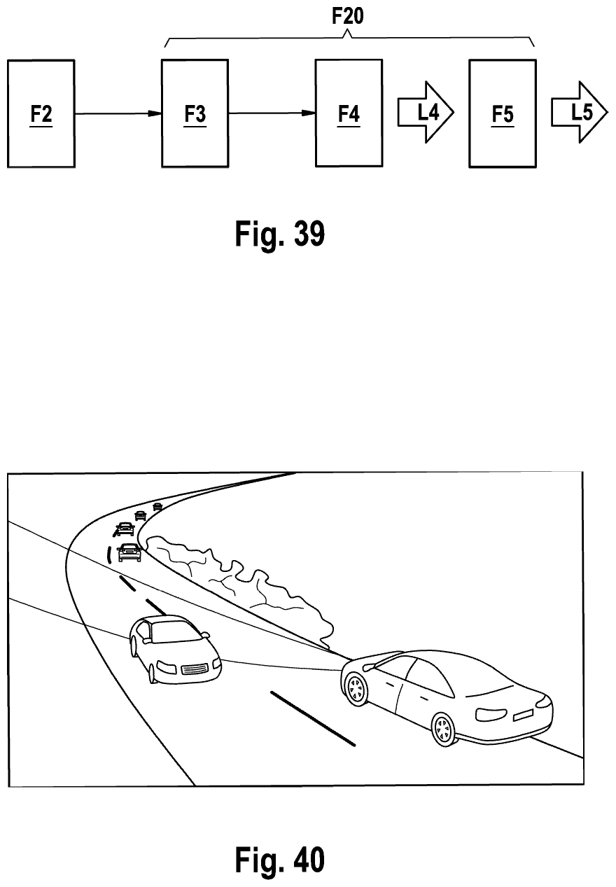

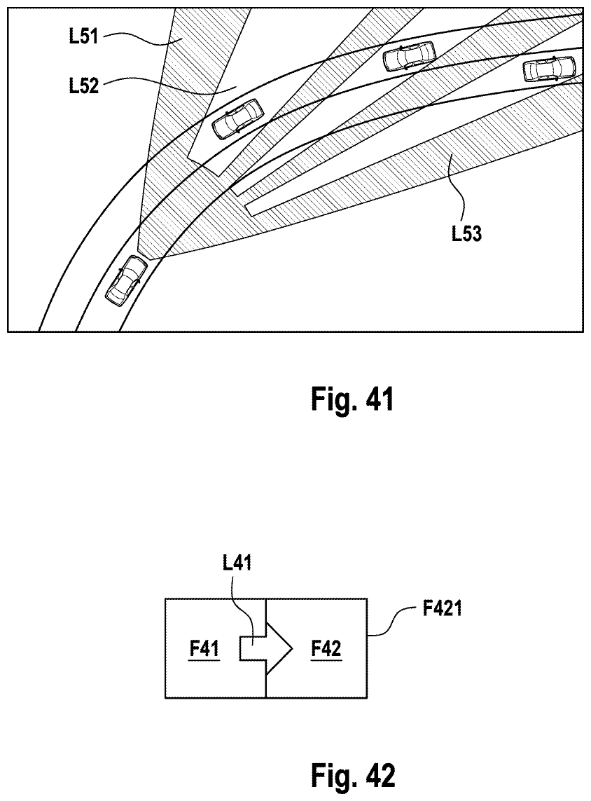

FIG. 39 shows an adaptive headlight or vehicle headlight F20 for the situation-dependent or traffic-dependent illumination of the surroundings or carriageway in front of the motor vehicle 20 depending on a surround sensor system F2 of the motor vehicle 20. For this purpose, the vehicle headlight F20 shown schematically in FIG. 39 comprises an illumination device F4, which is actuated by means of a controller F3 of the vehicle headlight F20. Light L4 generated by the illumination device F4 is emitted by the vehicle headlight F20 in the form of an illumination pattern L5 by means of an objective F5, which may comprise one or more optical lens elements or headlight lenses. Examples of corresponding illumination patterns are shown in FIGS. 40 and 41, and the websites web.archive.org/web/20150109234745/http://www.audi.de/content/de/brand/de/vorsprung_durch_technik/content/2013/08/Audi-A8-erstrahlt-in-neuem-Licht.html (retrieved on 5.9.2019) and www.all-electronics.de/matrix-led-und-laserlicht-bietet-viele-vorteile/(retrieved on 2.9.2019). In the configuration according to FIG. 41, the illumination pattern L5 comprises full-beam regions L51, dimmed regions L52 and cornering light L53.

FIG. 42 shows an embodiment of the illumination device F4, wherein it comprises a light-source assembly F41 having a plurality of individually adjustable regions or pixels. Therefore, up to 100 pixels, up to 1,000 pixels or no less than 1,000 pixels may for example be provided, which can be individually actuated by means of the controller F3 to the effect that they can be individually activated or deactivated, for example. It may be provided that the illumination device F4 also comprises front optics F42 for generating a light pattern (such as L4) on the light exit area F421 on the basis of the accordingly actuated regions or pixels of the light-source assembly F41 or according to the light L41 directed into the front optics F42.

Within the meaning of this disclosure, matrix headlights may also be matrix SSL HD headlights. Examples of headlights of this kind are found at the links www.springerprofessional.de/fahrzeug-lichttechnik/fahrzeugsicherheit/hella-bringt-neues-ssl-hd-matrix-lichtsystem-auf-den-markt/17182758 (retrieved on 28.5.2020), www.highlight-web.de/5874/hella-ssl-hd/ (retrieved on 28.5.2020) and www.hella.com/techworld/de/Lounge/Unser-Digital-Light-SSL-HD-Lichtsystem-ein-neuer-Meilenstein-der-automobilen-Lichttechnik-55548/ (retrieved on 28.5.2020).

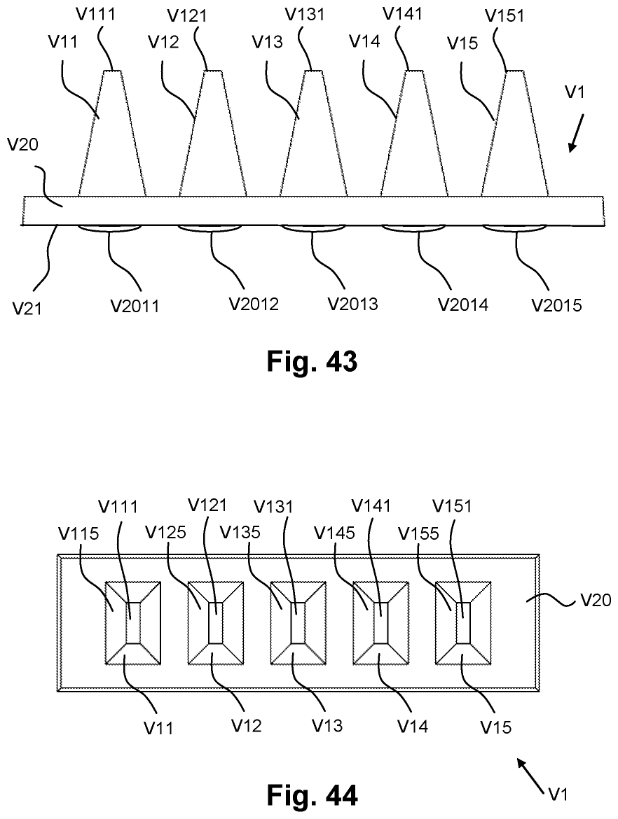

FIG. 43 is a side view of an integral front optics array V1. FIG. 44 is a rear plan view of the front optics array V1. The front optics array V1 comprises a base part V20, on which lenses V2011, V2012, V2013, V2014 and V2015 and front optics V11 having a light entrance area V111, front optics V12 having a light entrance area V121, front optics V13 having a light entrance area V131, front optics V14 having a light entrance area V141 and front optics V15 having a light entrance area V151 are molded. The side surfaces V115, V125, V135, V145, V155 of the front optics V11, V12, V13, V14, V15 are press molded and are formed such that light which enters the relevant light entrance area V111, V121, V131, V141 or V151 by means of a light source is subjected to total reflection (TIR), such that this light exits the base part V20 or the surface V21 of the base part V20 which forms the common light exit area of the front optics V11, V12, V13, V14 and V15. The rounding radii between the light entrance areas V111, V121, V131, V141 and V151 at the transition to the side surfaces V115, V125, V135, V145 and V155 are e.g. 0.16 to 0.2 mm.

FIG. 45 is a schematic view of a vehicle headlight V201 or motor-vehicle headlight. The vehicle headlight V201 comprises a light-source assembly VL, for example comprising LEDs, for directing light into the light entrance area V111 of the front optics V11 or the light entrance areas V112, V113, V114 and V115 (not shown in greater detail) of the front optics V12, V13, V14 and V15. In addition, the vehicle headlight V201 comprises a secondary lens V2 for imaging the light exit surface V21 of the front optics array V1.

Another suitable field of application for lenses produced according to the disclosure is for example disclosed in DE 10 2017 105 888 A1 or the headlight described with reference to FIG. 46. In this case, by way of example, FIG. 46 shows a light module (headlight) M20 which comprises a light-emission unit M4 having a plurality of punctiform light sources that are arranged in a matrix-like manner and each emits light ML4 (with a Lambert's emission characteristic), and also comprises a concave lens M5 and projection optics M6. In the example according to FIG. 46 shown in DE 10 2017 105 888 A1, the projection optics M6 comprises two lenses which are arranged one behind the other in the beam path and have been produced according to a method corresponding to the above-mentioned method. The projection optics M6 images the light ML4 emitted by the light-emission unit M4 and light ML5 that is further shaped after passing through the concave lens M5, in the form of a resulting light distribution ML6 of the light module M20, on a carriageway in front of the motor vehicle in which the light module or headlight is (has been) installed.

The light module M20 comprises a controller denoted by reference sign M3, which actuates the light-emission unit M4 depending on the values from a sensor system or surround sensor system M2. The concave lens M5 comprises a concave curved exit surface on the side facing away from the light-emission unit M4. The exit surface of the concave lens M5 deflects light ML4 directed into the concave lens M5 from the light-emission unit M4 at a large emission angle towards the edge of the concave lens by means of total reflection, such that said light is not transmitted through the projection optics M6. According to DE 10 2017 105 888 A1, light beams that are emitted from the light-emission unit M4 at a “large emission angle” are referred to as those light beams which (without arranging the concave lens M5 in the beam path) due to optical aberrations would be imaged poorly, for example in a blurred manner, on the carriageway by means of the projection optics M6 and/or could result in scattered light, which reduces the contrast of the imaging on the carriageway (see also DE 10 2017 105 888 A1). It may be provided that the projection optics M6 can only image light in focus at an opening angle limited to approximately +/−20°. Light beams having opening angles of greater than +/−20°, for example greater than +/−30°, are therefore prevented from impinging on the projection optics M6 by arranging the concave lens M5 in the beam path.

The light-emission unit M4 may be designed differently. According to one configuration, the individual punctiform light sources of the light-emission unit M4 each comprise a semiconductor light source, for example a light-emitting diode (LED). The LEDs may be actuated individually or in groups in a targeted manner in order to activate or deactivate or dim the semiconductor light sources. The light module M20 e.g. comprises more than 1,000 individually actuatable LEDs. For example, the light module M20 may be designed as what is known as a pAFS (micro-structured adaptive front-lighting system) light module.

According to an alternative option, the light-emission unit M4 comprises a semiconductor light source and a DLP or micromirror array, which comprises a large number of micromirrors which can be actuated and tilted individually, wherein each of the micromirrors forms one of the punctiform light sources of the light-emission unit M4. The micromirror array for example comprises at least 1 million micromirrors, which may for example be tilted at a frequency of up to 5,000 Hz.

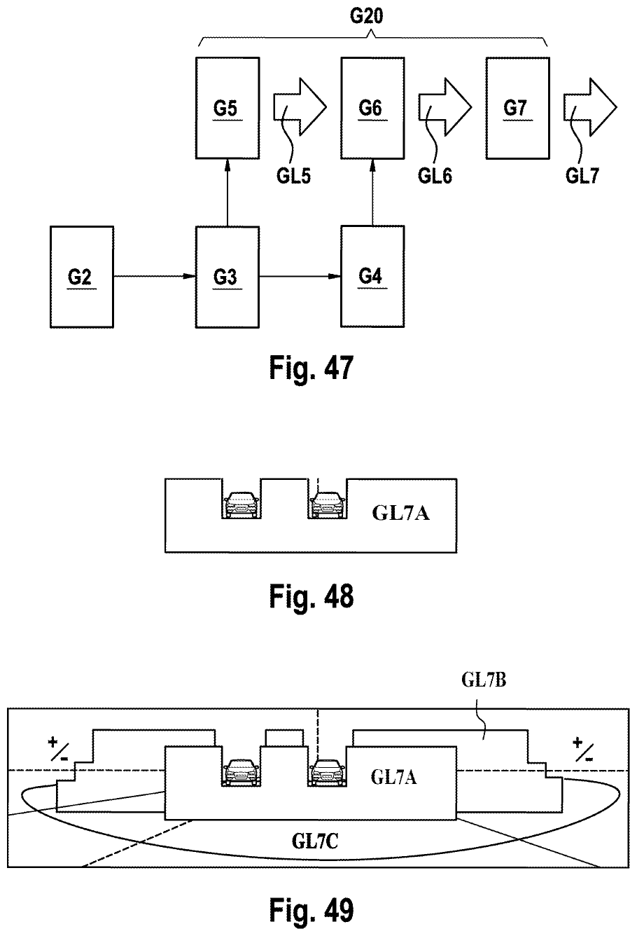

Another example of a headlight system or light module (DLP system) is disclosed by the link www.al-lighting.com/news/article/digital-light-millions-of-pixels-on-the-road/ (retrieved on 13.4.2020). FIG. 47 schematically shows a corresponding headlight module or vehicle headlight for generating an illumination pattern denoted by GL7A in FIG. 48. The adaptive headlight G20 schematically shown in FIG. 47 for the situation-dependent or traffic-dependent illumination of the surroundings or carriageway in front of the motor vehicle 20 on the basis of a surround sensor system G2 of the motor vehicle 20. Light GL5 generated by the illumination device G5 is shaped by means of a system of micromirrors G6, as for example also shown in DE 10 2017 105 888 A1, to form an illumination pattern GL6 which, by means of projection optics G7 for adaptive illumination, radiates suitable light GL7 in front of the motor vehicle 20 or in the surroundings onto the carriageway in front of the motor vehicle 20. A suitable system G6 of movable micromirrors is disclosed by the link www.al-lighting.com/news/article/digital-light-millions-of-pixels-on-the-road/ (retrieved on 13.4.2020).

A controller G4 is provided for actuating the system G6 comprising movable micro-mirrors. In addition, the headlight G20 comprises a controller G3 both for synchronizing with the controller G4 and for actuating the illumination device G5 depending on the surround sensor system G2. Details of the controllers G3 and G4 can be found at the link www.al-lighting.com/news/article/digital-light-millions-of-pixels-on-the-road/ (retrieved on 13.4.2020). The illumination device G5 may for example comprise an LED assembly or a comparable light-source assembly, optics such as a field lens (which, for example, has likewise been produced according to the above-described method) and a reflector.

The vehicle headlight G20 described with reference to FIG. 47 may for example be used in connection with other headlight modules or headlights in order to obtain a superimposed overall light profile or illumination pattern. This is shown by way of example in FIG. 49, wherein the overall illumination pattern is compiled from the illumination patterns GL7A, GL7B and GL7C. In this process, it may for example be provided that the illumination pattern GL7C is generated by means of the headlight 20 and the illumination pattern GL7B is generated by means of the headlight V201.

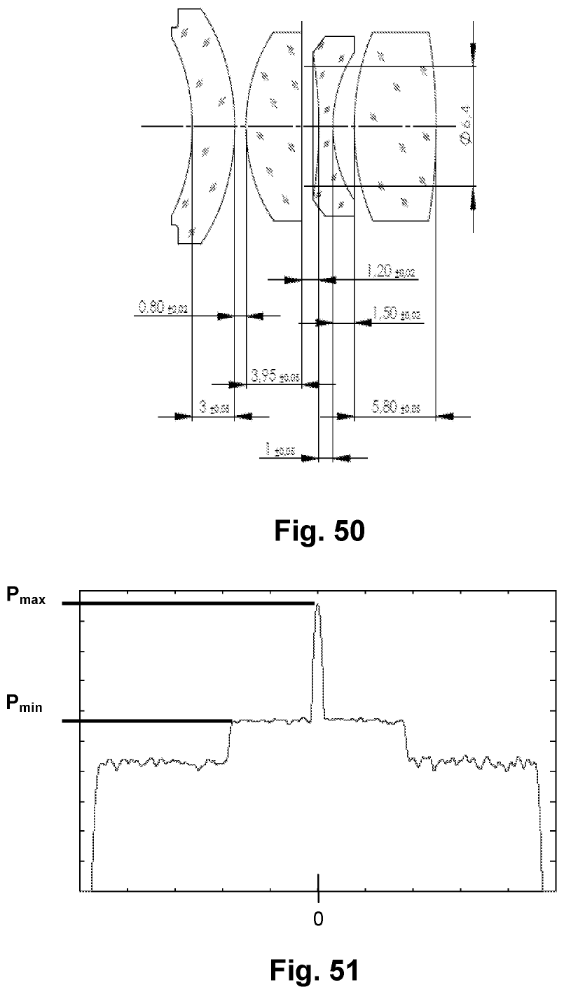

Sensors for the above-mentioned headlights for example comprise a camera and analysis or pattern recognition for analyzing a signal provided by the camera. A camera for example comprises an objective or a multiple-lens objective as well as an image sensor for imaging an image generated by the objective on the image sensor. In a particularly suitable manner, an objective is used as disclosed in U.S. Pat. No. 8,212,689 B2 (incorporated by reference in its entirety) and shown by way of example in FIG. 50. An objective of this kind is particularly suitable because it prevents or significantly reduces parasitic images, since an objective of this kind can for example prevent a parasitic image of a vehicle coming in the other direction with its lights on being confused with a vehicle driving in front with its lights on. A suitable objective, for example for infrared light and/or visible light, images an object in an image plane, wherein, in relation to the imaging of an object, it is applicable to each point within the image circle of the objective or to at least one point within the image circle of the objective that Pdyn 70 dB, for example Pdyn 80 dB, for example Pdyn 90 dB, wherein Pdyn is equal to 10·log(Pmax/Pmn), as shown in FIG. 51, wherein Pmax is the maximum luminous power of a point in the image plane for imaging a point of the object, and wherein Pmin is the luminous power of another point in the image plane for imaging the point on the object, the luminous power of which in relation to the imaging of the point of the object is greater than the luminous power of each other point in the image plane in relation to the imaging of the point of the object or wherein Pmin is the maximum luminous power of the parasitic-image signals from the point of the object as imaged at another point. The lenses or some of the lenses of the objective shown in FIG. 50 can be produced according to the claimed or disclosed method, wherein it is for example provided that the accordingly produced lenses comprise a circumferential or partially circumferential edge, in a departure from the view in FIG. 50.

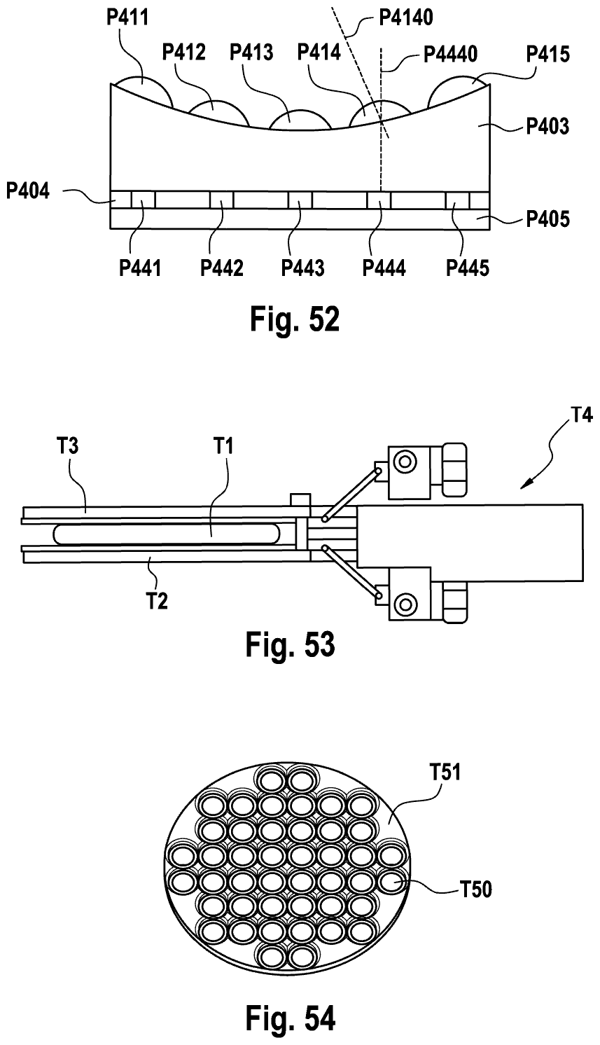

Another embodiment for the use of the method described in the following is the production of microlens arrays, for example microlens arrays for projection displays. A microlens array of this kind or its use in a projection display are shown in FIG. 52. Microlens arrays or projection displays are described in WO 2019/072324 A1, DE 10 2009 024 894 A1, DE 10 2011 076 083 A1 and DE 10 2020 107 072 A1, for example. The microlens array according to FIG. 52 is a one-piece, pressed glass part (pressed from a gob), which combines in one-piece the substrate or carrier P403 and the projection lenses P411, P412, P413, P414, P415. In addition, the projection lenses P411, P412, P413, P414, P415 are arranged in a concave contour or following a parabolic contour to each other. Owing to this arrangement, the optical axis P4140 of the projection lenses, such as the projection lens P414, is tilted relative to the orthogonal P4440 of the object structure P444 (see below), for example. A metal mask P404 is arranged on a side of the carrier P403 facing away from the projection lenses P411, P412, P413, P414, P415, wherein said mask comprises recesses, in which object structures P441, P442, P443, P444 and P445 are arranged. An illumination layer P405 is arranged above the object structures. It may also be provided that the illumination layer P405 comprises a transparent electrode, a light-emitting layer and a reflective back electrode. A light source as disclosed in U.S. Pat. No. 8,998,435 B2 also comes into consideration as an alternative illumination means.

The device 1 according to FIG. 1 for producing optical elements such as the headlight lens 202 comprises a melting unit 2, such as a trough, in which soda-lime glass, in the present embodiment DOCTAN®, is melted in a process step 120 according to FIG. 2A. The melting unit 2 may e.g. comprise an adjustable outlet 2B. In a process step 121, liquid glass is brought from the melting unit 2 into a preform device 3 for producing a preform, such as a gob, for example having a mass of from 10 g to 400 g, for example a mass of from 50 g to 250 g, or a preform that is close to the final contours (a preform that is close to the final contours has a contour that is similar to the contour of the motor-vehicle headlight lens to be pressed or to the lens-like free-form for motor-vehicle headlights). This may e.g. comprise molds in which a defined quantity of glass is cast. The preform is produced in a process step 122 by means of the preform device 3.

The process step 122 is followed by a process step 123, in which the preform is transferred to the cooling apparatus 5 by means of a transfer station 4 and is cooled by means of the cooling apparatus 5 at a temperature of between 300° C. and 500° C., for example of between 350° C. and 450° C. In the present embodiment, the preform is cooled for over 10 minutes at a temperature of 400° C., such that its temperature in the interior is approximately 500° C. or greater, for example 600° C. or greater, for example T_{G} or greater.

In a subsequent process step 124, the preform is heated by means of the heating apparatus 6 at a temperature of no less than 700° C. and/or no greater than 1600° C., for example of between 1000° C. and 1250° C., wherein it is for example provided that the preform is heated such that the temperature of the surface of the preform after the heating is at least 100° C., for example at least 150° C., greater than T_{G} and is for example 750° C. to 900° C., for example 780° C. to 850° C. A combination of the cooling apparatus 5 with the heating apparatus 6 is an example of a temperature-control apparatus for setting the temperature gradient.

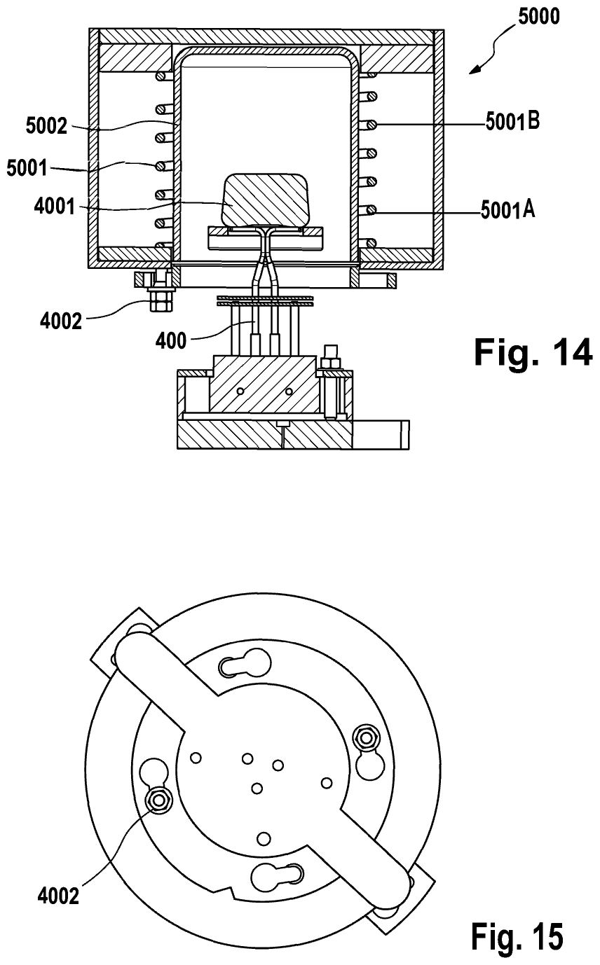

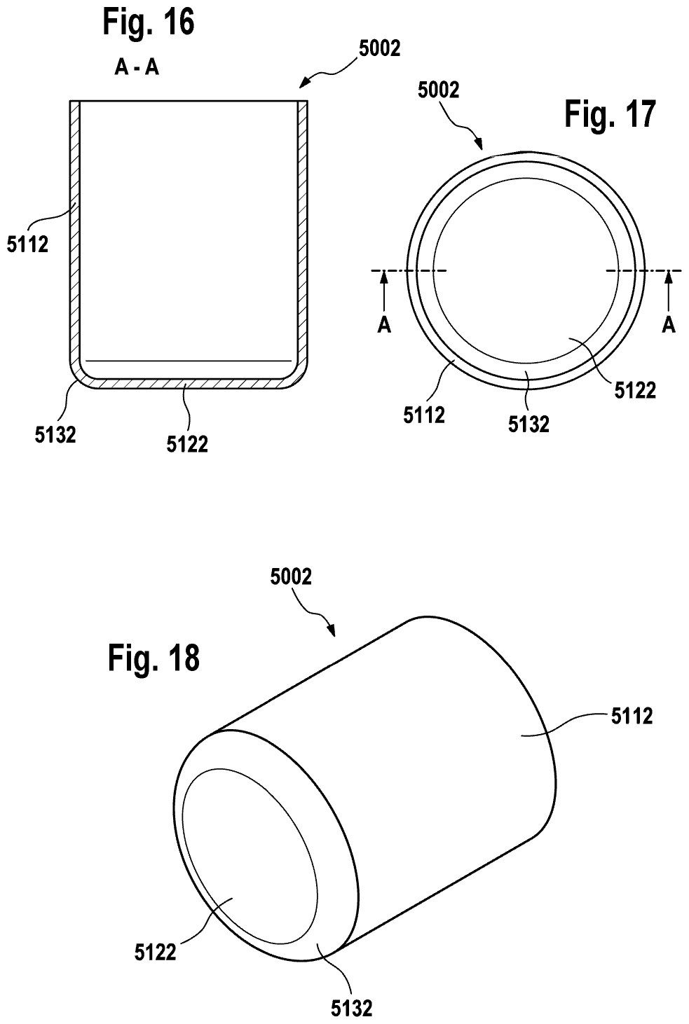

In one configuration, this temperature-control apparatus and/or the combination of the heating apparatuses 5 and 6 is designed as a hood-type annealing furnace 5000, as shown in FIG. 14. FIG. 14 shows a preform to be heated in the form of a gob 4001 on a support device 400 designed as a lance. Heating coils 5001 are provided for heating the gob 4001. In order to protect these heating coils 5001 against a defective gob bursting open, the interior of the hood-type annealing furnace 5000 is lined with a protective cover 5002. FIG. 15 is a view of the hood-type annealing furnace 5000 according to FIG. 14 from below, FIG. 16 is a cross section through the protective cover 5002 according to FIG. 14, and FIG. 17 is a view into the interior of the protective cover 5002 according to FIG. 14. In the embodiment according to FIG. 14, this protective cover 5002 is configured to be cup-shaped. In this configuration, the protective cover 5002 comprises a cylindrical region 5112, which transitions into a covering region 5122 via a rounded region 5132. The radius of curvature of the curved region 5132 is between 5 mm and 20 mm, for example. In the embodiment according to FIG. 16, the radius of curvature of the curved region 5132 is approximately 10 mm. The protective cover 5002 is secured in the hood-type annealing furnace 5000 and is fixed by a nut 4002. In another preferred configuration, a bayonet catch is provided, by means of which a protective cover can be changed more rapidly.

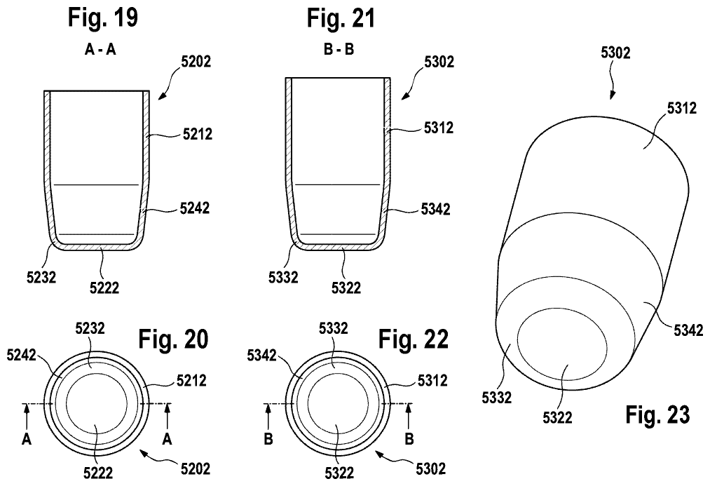

FIG. 19 is a cross section through an embodiment of another protective cover 5202. FIG. 20 is a view into the interior of the protective cover 5202 according to FIG. 19. The protective cover 5202 is likewise configured to be cup-shaped, but also comprises a conical region 5242 in addition to a cylindrical region 5212. The conical region 5242 transitions into a covering region 5222 via a curvature 5232. The conical region 5242 defines a volume which is between 30% and 50% of the volume of the cavity in the protective cover 5202.

FIG. 21 is a cross section through an embodiment of another protective cover 5302, FIG. 22 is a view into the interior of the protective cover 5302 according to FIG. 21, and FIG. 23 is a perspective view of the protective cover 5302. The protective cover 5302 is likewise configured to be cup-shaped, but also comprises a conical region 5342 in addition to a cylindrical region 5312. The conical region 5342 transitions into a covering region 5322 via a curvature 5332. The conical region 5342 defines a volume which is between 30% and 50% of the volume of the cavity in the protective cover 5302.

The protective covers 5002, 5202, 5302 for example have the purpose of protecting the heating coils 5001 positioned in the furnace against glass bursting open. If a gob bursts open in the furnace without this protective cover, a part of the glass or a large part of the glass clings to the heating coils 5001 and thus significantly impairs the heating process for the next gob or even destroys the heating coils 5001 and thus destroys the entire functional capability of the furnace. The protective covers 5002, 5202, 5302 are removed after a gob has burst open and are replaced by other protective covers. The protective covers 5002, 5202, 5302 are adapted to the size of the furnace.

The heating coils 5001 may consist of or comprise a plurality of independently actuatable heating coils 5001A and 5001B. Because said coils are independently actuatable, a particularly suitable, for example homogeneous, temperature (distribution) can be obtained inside the furnace or inside the protective covers 5002, 5202, 5303. In addition to their function of reducing the severity of a gob bursting open, the protective covers 5002, 5202, 5303 contribute to this desired temperature distribution. The protective covers consist of or comprise silicon carbide, for example.

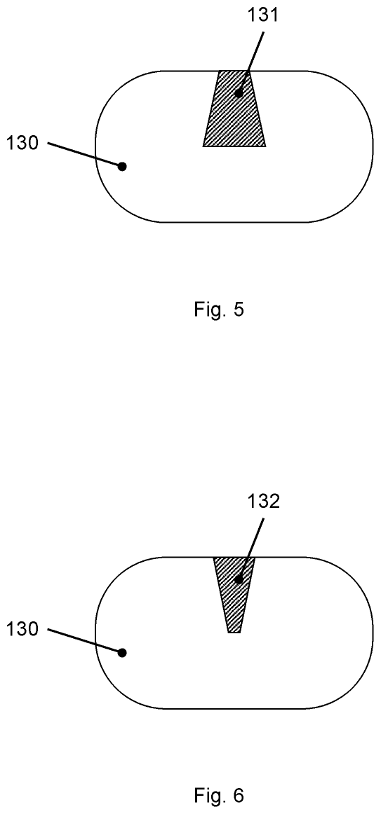

As explained below with reference to FIGS. 5 and 6, the process steps 123 and 124 are coordinated with one another such that a reversal of the temperature gradient is obtained. In this case, FIG. 5 shows an exemplary preform 130 before entering the cooling apparatus 5 and FIG. 6 shows the preform 130 with a reversed temperature gradient after leaving the heating apparatus 6. While the blank is hotter inside than outside before the process step 123 (with a continuous temperature curve), it is hotter outside than inside after the process step 124 (with a continuous temperature curve). The wedges denoted by reference signs 131 and 132 symbolize the temperature gradients here, wherein the width of a wedge 131 or 132 symbolizes a temperature.

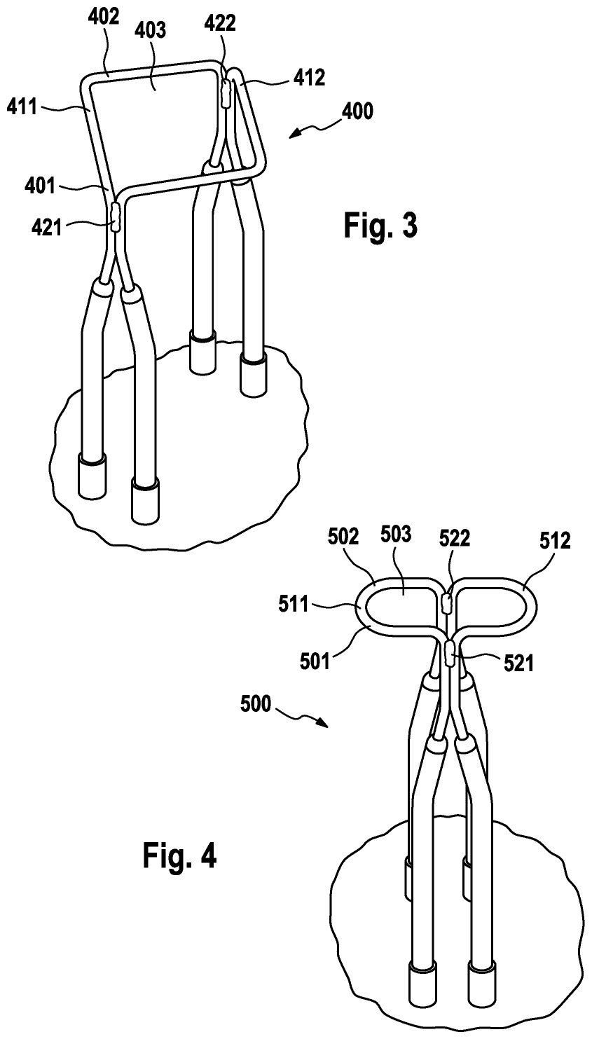

In order to reverse its temperature gradient, in one configuration, a preform resting on a cooled lance (not shown) is moved through the temperature-control device comprising the cooling apparatus 5 and the heating apparatus 6 (for example substantially continuously) or is held in one of the cooling apparatuses 5 and/or one of the heating apparatuses 6. A cooled lance is disclosed in DE 101 00 515 A1 and in DE 101 16 139 A1. Depending on the shape of the preform, FIGS. 3 and 4 for example show suitable lances. For example coolant flows through the lance in accordance with the counterflow principle. Alternatively or additionally, it may be provided that the coolant is additionally and/or actively heated.

For the term “lance”, the term “support device” is also used in the following. The support device 400 shown in FIG. 3 comprises a carrier body 401 having a hollow cross section and an annular support surface 402. The carrier body 401 is tubular at least in the region of the support surface 402 and is uncoated at least in the region of the support surface 402. The diameter of the hollow cross section of the carrier body 401, at least in the region of the support surface 402, is no less than 0.5 mm and/or no greater than 1 mm. The external diameter of the carrier body 401, at least in the region of the support surface, is no less than 2 mm and/or no greater than 3 mm. The support surface 402 spans a square base surface 403 having rounded corners. The carrier body 401 comprises two flow channels 411 and 412 for the coolant flowing therethrough, which each only extend over a section of the annular support surface 402, wherein the flow channels 411 and 412 are connected in a region in which they leave the support surface 402 by means of metallic filler material 421 and 422, for example solder.

The support device 500 shown in FIG. 4 comprises a carrier body 501 having a hollow cross section and an annular support surface 502. The carrier body 501 is tubular at least in the region of the support surface 502 and is uncoated at least in the region of the support surface 502. The diameter of the hollow cross section of the carrier body 501, at least in the region of the support surface 502, is no less than 0.5 mm and/or no greater than 1 mm. The external diameter of the carrier body 501, at least in the region of the support surface, is no less than 2 mm and/or no greater than 3 mm. The support surface 502 spans an oval base surface 503. The carrier body 501 comprises two flow channels 511 and 512 for the coolant flowing therethrough, which each only extend over a section of the annular support surface 502, wherein the flow channels 511 and 512 are connected in a region in which they leave the support surface 502 by means of metallic filler material 521 and 522, for example solder.

It may be provided that, after passing through the cooling apparatus 5 (in the form of a cooling path), preforms are removed and are supplied by means of a transport apparatus 41, for example, to an intermediate storage unit (e.g. in which they are stored at room temperature). In addition, it may be provided that preforms are conducted to the transfer station 4 by means of a transport apparatus 42 and are phased into the continuing process by heating in the heating apparatus 6 (for example starting from room temperature).

In a departure from the method described with reference to FIG. 2A, in the method described with reference to FIG. 2B, the process step 121 is followed by the process step 122′, in which the cast gobs are transferred to a cooling path 49 of the device 1A, as shown in FIG. 1A, by means of a transfer station 4. In this sense, a cooling path is for example a conveying apparatus, such as a conveyor belt, through which a gob is guided and is cooled in the process, for example with the addition of heat. The cooling is carried out to a certain temperature above room temperature or to room temperature, wherein the gob is cooled down to room temperature in the cooling path 49 or outside the cooling path 49. It is for example provided that a gob rests on a base made of graphite or a base containing graphite in the cooling path 49.

In the subsequent process step 123′ according to FIG. 2B, the gobs are supplied to a device 1B. The devices 1A and 1B may be in close proximity to one another, but may also be further away from one another. In the latter case, a transfer station 4A transfers the gobs from the cooling path 49 to a transport container BOX. The gobs are transported in the transport container BOX to the device 1B, in which a transfer station 4B removes the gobs from the transport container BOX and transfers them to a hood-type annealing furnace 5000. The gobs are heated in the hood-type annealing furnace 5000 (process step 124′).

Flat gobs, wafers or wafer-like preforms can also be used to produce microlens arrays. Wafers of this kind may be square, polygonal or round, for example having a thickness of from 1 mm to 10 mm and/or a diameter of 4 inches to 5 inches. In a departure from the previously described method, these preforms are not heated on support devices, as shown in FIGS. 3 and 4, but are clamped, as shown in FIG. 53. In this case, the reference sign T1 denotes a flat preform or wafer and reference signs T2 and T3 denote clamping devices for clamping the flat preform T1 or wafer. In this clamping assembly T4 comprising the clamping devices T2 and T3, this flat preform is heated in a heating apparatus, such as the hood-type annealing furnace 5000. In this case, it may be provided that this preform T1 is not inserted into the heating apparatus from below, but instead from the side. Furthermore, it is for example provided that the clamped flat preform T1 rotates in the heating apparatus in order to prevent the flat preform T1 from bowing. In this process, the preform T1 is heated in the heating apparatus, for example while rotating, until the heated preform T1 can be pressed. The preform T1 is then placed onto a press mold (described in greater detail below) in a, for example rotating, movement wherein the clamping devices T2 and T3 of the clamping assembly T4 are opened such that the preform T1 rests on the press mold. During the pressing process, the clamping devices T2 and T3 may remain in the press. After the pressing process, the clamping devices T2 and T3 grip the pressed preform T1 again and convey the preform T1 into a region outside the press.

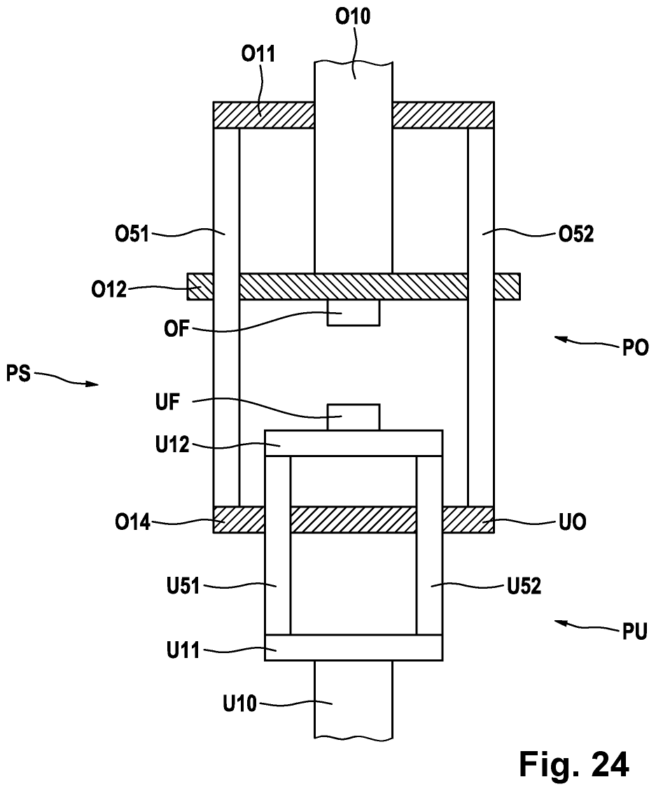

A press 8, onto which a preform is transferred by means of a transfer station 7, is provided behind the heating apparatuses 6 or 5000. The preform is press molded, for example on both sides, to form an optical element, such as the headlight lens 202, in a process step 125 by means of the press 8. A suitable mold set is disclosed e.g. in EP 2 104 651 B1. FIG. 24 is a schematic view of a pressing station PS for pressing an optical element from a heated blank. The pressing station PS is part of the press 8 according to FIGS. 1 and 1B. The pressing station PS comprises an upper pressing unit PO and a lower pressing unit PU. For the pressing, a mold OF (upper mold), which is moved by means of a press drive or by means of an actuator O10, and a mold UF (lower mold), which is moved by means of a press drive or by means of an actuator U10, are moved towards one another. The mold UF is connected to a mold-side movable connector U12, which is in turn connected to an actuator-side movable connector U11 by means of movable guide rods U51, U52. The actuator U10 is in turn connected to the actuator-side movable connector U11, such that the mold UF is movable by means of the actuator U10. The movable guide rods U51 and U52 extend through recesses in a fixed guide element UO such that any displacement or movement of the movable guide rods U51 and U52 and therefore of the mold UF perpendicularly to the movement direction is prevented or reduced or limited.

The pressing unit PO comprises an actuator O10, which moves the mold OF and is connected to a movable guide element O12. The pressing unit PO also comprises a frame, which is formed by an actuator-side fixed connector O11 and a mold-side fixed connector O14 as well as fixed guide rods O51 and O52, which connect the actuator-side fixed connector O11 to the mold-side fixed connector O14. The fixed guide rods O51 and O52 are guided through recesses in the movable guide element O12, such that they prevent, reduce or avoid any movement or displacement of the mold OF orthogonally to the movement direction of the actuator O10 or mold OF.

In the embodiment shown, the pressing units PO and PU are linked in that the fixed guide element UO is identical to the mold-side fixed connector O14. By linking or chaining the two pressing units PO and PU of the pressing station PS together, particularly high quality (for example in the form of contour accuracy) of the headlight lenses to be pressed is achieved.

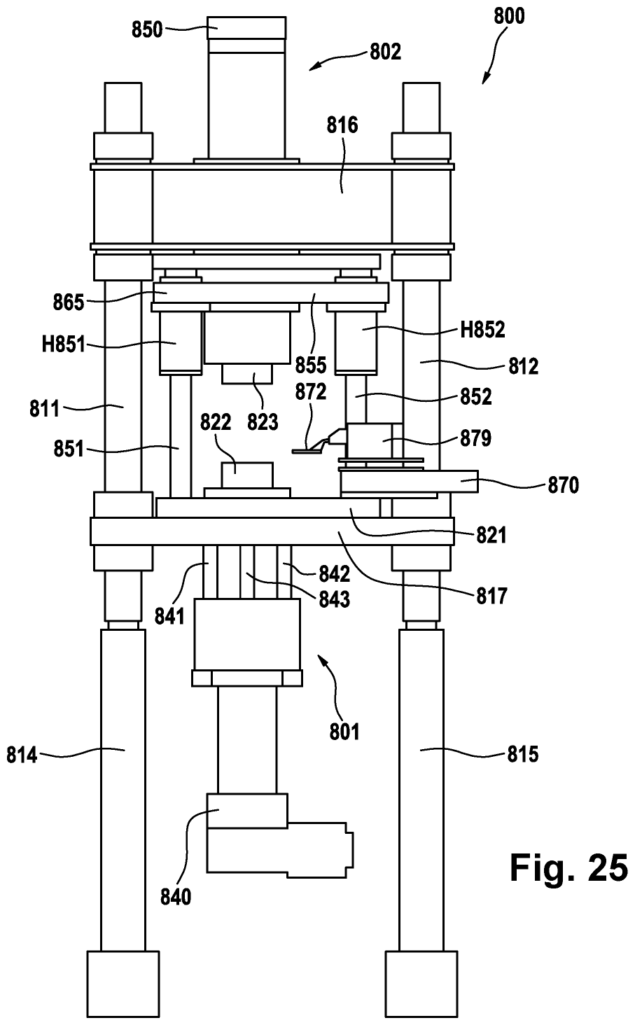

The pressing station 800 comprises a lower pressing unit 801 and an upper pressing unit 802 (see FIG. 25), wherein FIG. 25 shows an embodiment of a pressing station 800, by means of which optical elements, such as headlight lenses, can be pressed in a particularly preferable and suitable manner. The pressing station 800 is an embodiment of the pressing station PS from FIG. 24. The pressing unit 801 is an embodiment of the lower pressing unit PU in FIG. 24 and the pressing unit 802 is an embodiment of the upper pressing unit PO in FIG. 24. The pressing station 800 comprises a pressing frame, which, in an exemplary configuration, comprises the interconnected rods 811 and 814 as well as the interconnected rods 812 and 815. The rods 811 and 812 are interconnected by a lower plate 817 and an upper connection part 816 and thus form a pressing frame, which receives the lower pressing unit 801 and the upper pressing unit 802.

The lower pressing unit 801 comprises a press drive 840 corresponding to the actuator U10, by means of which drive three rods 841, 842, 843 are movable, in order to move a lower press mold 822 that is coupled to the rods 841, 842, 843 and corresponds to the mold UF. The rods 841, 842, 843 are guided through bores or holes (not shown) in the plate 817 and a plate 821, which prevent or considerably reduce a deviation or movement of the press mold 822 in a direction orthogonal to the movement direction. The rods 841, 842, 843 are embodiments of the movable guide rods U51 and U52 according to FIG. 24. The plate 817 is a configuration or implementation of the fixed guide element UO.

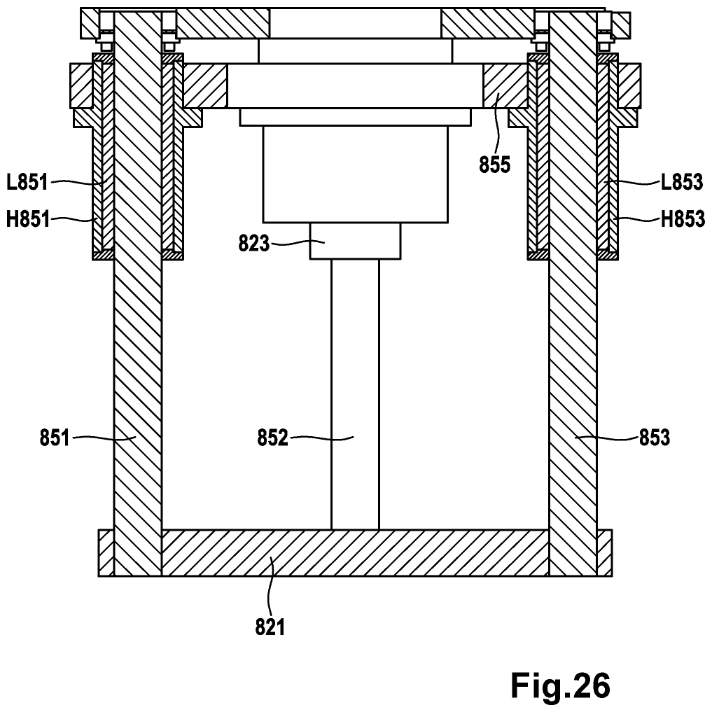

The upper pressing unit 802 shown in FIG. 26 comprises a press drive 850 which corresponds to the actuator O10 and is held by the upper connection part 816, which corresponds to the actuator-side fixed connector O11. A plate 855 which corresponds to the movable guide element O12 and comprises guide rods 851, 852 and 853 as well as an upper press mold 823 is guided by means of the press drive 850. The guide rods 851, 852 and 853 correspond to the fixed guide rods OS1 and OS2 in FIG. 24. The press mold 823 corresponds to the mold OF in FIG. 24. For the guidance, sleeves H851, H852 and H853 comprising bearings L851 and L853 are also provided as an implementation of the recesses in the movable guide plate O12 from FIG. 24, which surround the guide rods 851, 852 and 853. The plates 821 and 817 are fixed to one another and thus form the fixed guide element UO (plate 817) and the mold-side fixed connector O14 (plate 821).

Reference sign 870 denotes a movement mechanism by means of which an induction heater 879 comprising an induction loop 872 can be moved towards the lower mold 822 in order to heat it by means of the induction loop 872. After the heating by means of the induction loop 872, the induction heater 879 is moved back into its starting position again. A gob or preform is placed onto the press mold 822 and, by moving the press molds 822 and 823 towards one another, is press molded (on both sides) to form a head-light lens.

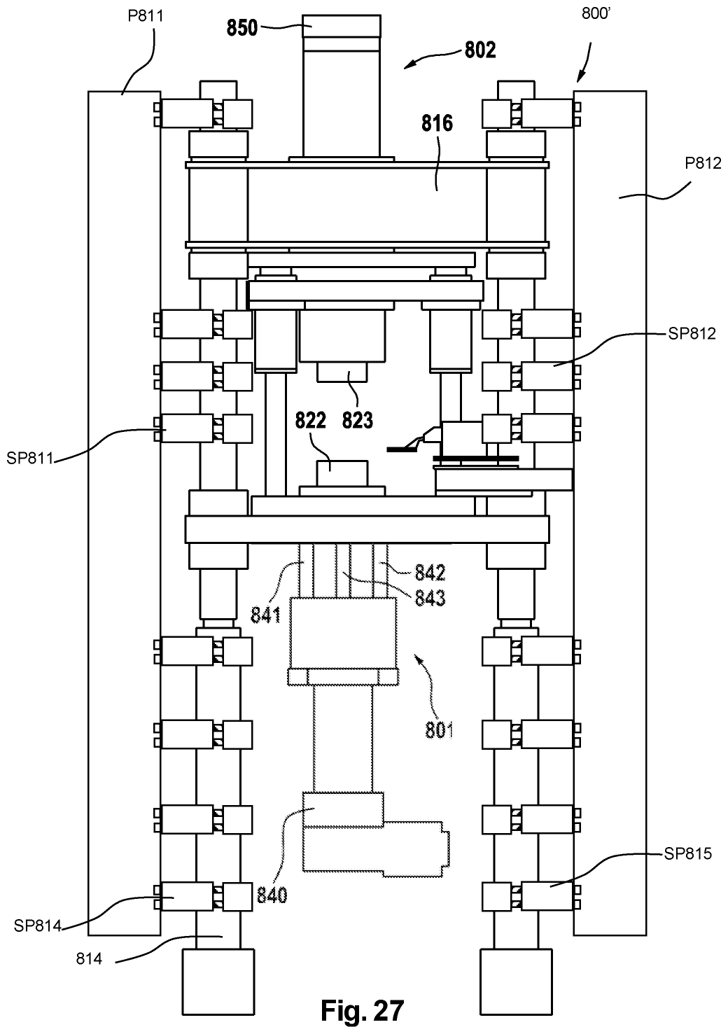

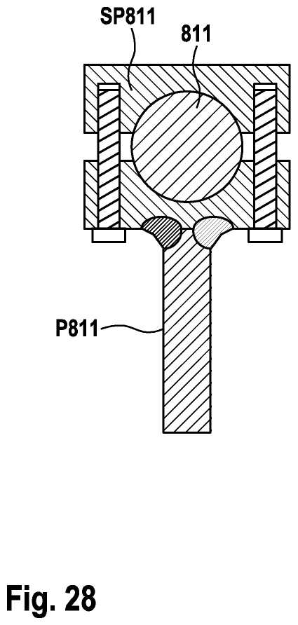

FIG. 27 shows another pressing station 800′, likewise as an embodiment of the pressing station PS according to FIG. 24. In a modification to the pressing station 800, a reinforcement profile P811, P812 is for example provided for each of the rods 811, 812 or the rods 814, 815, wherein the reinforcement profile P811, P812 is connected to the rods 811, 812, 814, 815 by means of clamps SP811, SP812, SP814, SP815. FIG. 28 is, by way of example, a view of a detail of a clamp SP811 of this kind, wherein one half of the clamp is welded to the reinforcement profile P811.

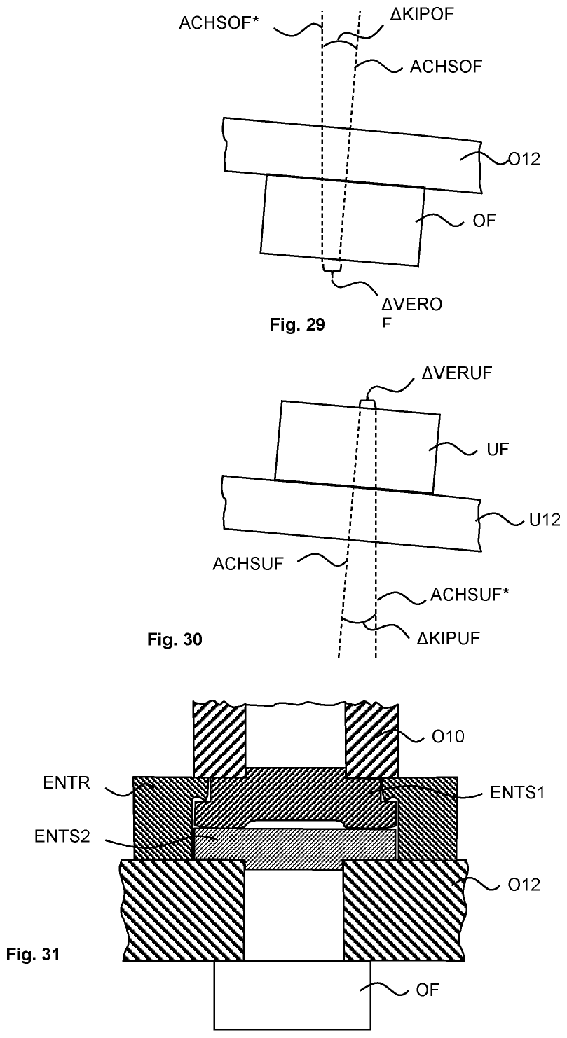

The components are, for example, coordinated with one another and/or dimensioned such that the maximum tilting ΔKIPOF or the maximum angle of the tilting of the mold OF (corresponding to the angle between the target pressing direction ACHSOF* and the actual pressing direction ACHSOF), as shown in FIG. 29, is no greater than 10^{-2°}, for example no greater than 5.10^{-3°}. Furthermore, it is provided that the radial offset ΔVEROF, i.e. the offset of the mold OF from its target position in the direction orthogonal to the target pressing direction ACHSOF*, is no greater than 50 μm, for example no greater than 30 μm, or no greater than 20 μm, or no greater than 10 μm.

The components are, for example, coordinated with one another and/or dimensioned such that the maximum tilting ΔKIPUF or the maximum angle of the tilting of the mold UF (corresponding to the angle between the target pressing direction ACHSUF* and the actual pressing direction ACHSUF), as shown in FIG. 30, is no greater than 10^{-2°}, for example no greater than 5.10^{-3°}. Furthermore, it is provided that the radial offset ΔVERUF, i.e. the offset of the mold UF from its target position in the direction orthogonal to the target pressing direction ACHSUF*, is no greater than 50 μm, for example no greater than 30 μm, or no greater than 20 μm, or no greater than 10 μm.

Additionally or alternatively, it may be provided that the actuator O10 is decoupled with regard to torsion from the movable guide element O12 with the mold OF. In addition, it may be provided that the actuator U10 is also decoupled with regard to torsion from the mold-side movable connector U12 with the mold UF. FIG. 31 shows decoupling of this kind on the basis of the example of decoupling the actuator O10 from the mold OF together with the movable guide element O12. The decoupler, which comprises the ring ENTR and the discs ENTS1 and ENT2, prevents any torsion from the actuator O10 acting on the mold OF.

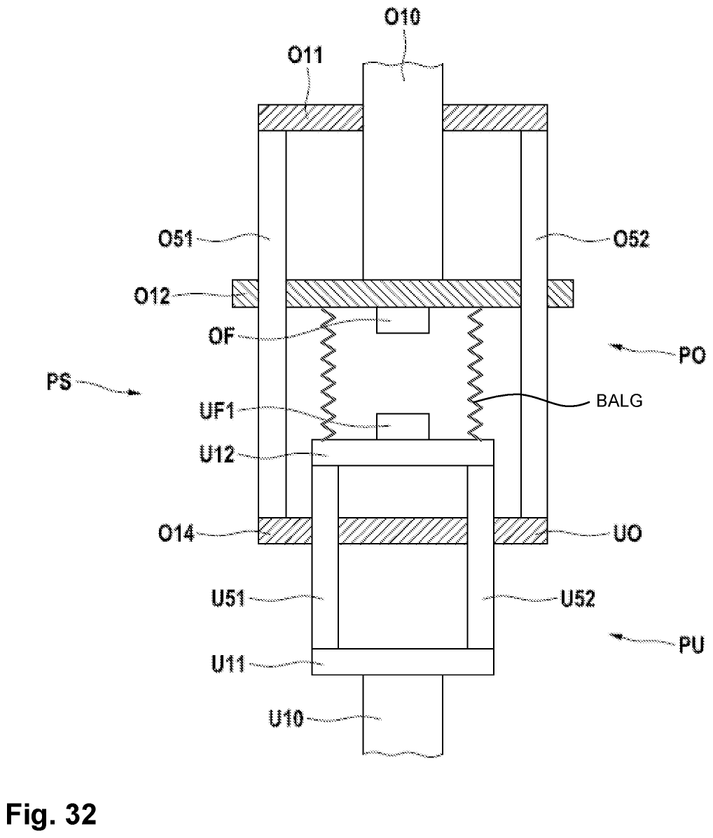

The method described may also be carried out in connection with pressing under vacuum or near vacuum or at least under negative pressure in a chamber, as disclosed by way of example in JP 2003-048728 A. The method described may also be carried out in connection with pressing under vacuum or near vacuum or at least under negative pressure by means of a bellows, as explained in the following on the basis of the pressing station PS in FIG. 32 by way of example. In this case, it is provided that a bellows BALG is provided or arranged between the movable guide element O12 and the mold-side movable connector U12 for closing the molds OF and UF in an airtight manner or at least in a substantially airtight manner. Suitable methods are for example disclosed in the above-mentioned JP 2003-048728 A (incorporated by reference in its entirety) and in WO 2014/131426 A1 (incorporated by reference in its entirety). In a corresponding configuration, a bellows may be provided, as disclosed in WO 2014/131426 A1, at least in a similar manner. It may be provided that the pressing of an optical element, such as a headlight lens, is carried out by means of at least one lower mold UF and at least one upper mold OF,
(a) wherein the heated preform or blank or gob 4001 (glass) is placed in or on the lower mold UF,
(b) wherein (subsequently or thereafter) the upper mold OF and the lower mold UF (are positioned relative to one another and) are moved towards one another without the upper mold OF and the lower mold UF forming a closed overall mold (for example far enough that the distance (for example the vertical distance) between the upper mold and the blank is no less than 4 mm and/or no greater than 10 mm),
(c) wherein (subsequently or thereafter) the bellows BALG for producing an air-tight space, in which the upper mold OF and the lower mold UF are arranged, is closed,
(d) wherein (subsequently or thereafter) a vacuum or near vacuum or negative pressure is generated in the airtight space,
(e) wherein (subsequently or thereafter) the upper mold OF and the lower mold UF are moved towards one another (for example vertically) for (press) molding the optical lens element (for example on both sides or all sides), wherein it is for example provided that the upper mold OF and the lower mold UF contact one another or form a closed overall mold (in this case, the upper mold OF and the lower mold UF can be moved towards one another such that the upper mold OF is moved (vertically) towards the lower mold UF and/or the lower mold UF is moved (vertically) towards the upper mold OF),
(f) wherein subsequently or thereafter normal pressure is generated in the air-tight space,
(g) wherein subsequently or thereafter, in another exemplary configuration, the seal is opened or returned to its starting position,
(h) and wherein subsequently or thereafter or during steps f) and/or g), the upper mold OF and the lower mold UF are moved away from one another.

In another exemplary configuration, before pressing the optical element, such as a head-light lens (or between step (d) and step (e)), a predetermined waiting time is allowed to elapse. In an embodiment, the predetermined waiting time is no greater than 3 seconds (minus the duration of step (d)). In an embodiment, the predetermined waiting time is no less than 1 second (minus the duration of step (d)).

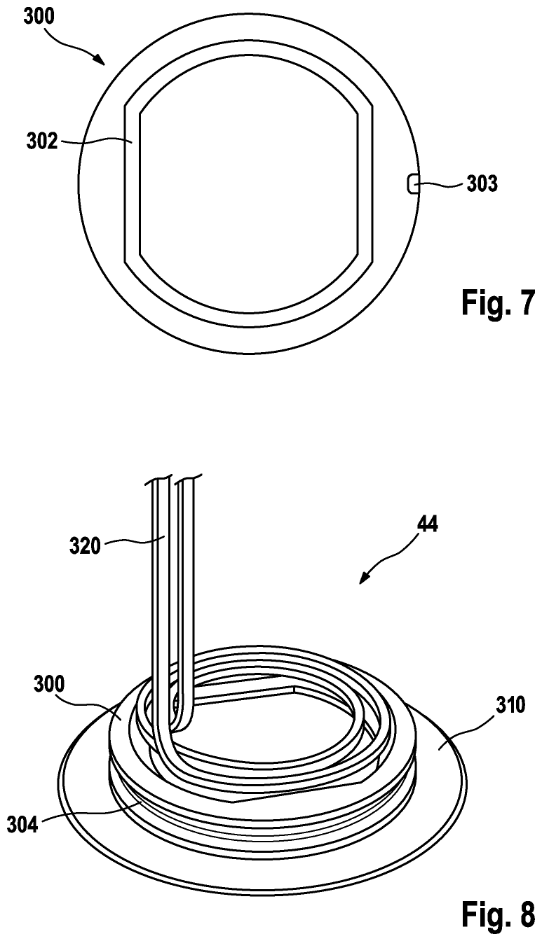

Following the pressing, the optical element (such as a headlight lens) is placed on a transport element 300 as shown in FIG. 7 by means of a transfer station 9. The annular transport element 300 shown in FIG. 7 consists of steel, for example of ferritic steel or martensitic steel. The annular transport element 300 comprises, on its inner face, a (corresponding) support surface 302, on which the optical element to be cooled, such as the headlight lens 202, is placed by its edge, such that the optical surfaces, such as the surface 205, are prevented from being damaged. Therefore, the (corresponding) support surface 302 and the support surface 261 of the lens edge 206 thus e.g. come into contact, as shown in FIG. 38, for example. Here, FIGS. 10 and 38 show the fixing and orientation of the headlight lens 202 on the transport element 300 by means of a limiting surface 305 or a limiting surface 306. The limiting surfaces 305 and 306 are for example orthogonal to the (corresponding) support surface 302. In this case, it is provided that the limiting surfaces 305, 306 have enough play relative to the headlight lens 202, such that the headlight lens 202 can be placed on the transport element 300 for example without the headlight lens 202 becoming tilted or jammed on the transport element 300.

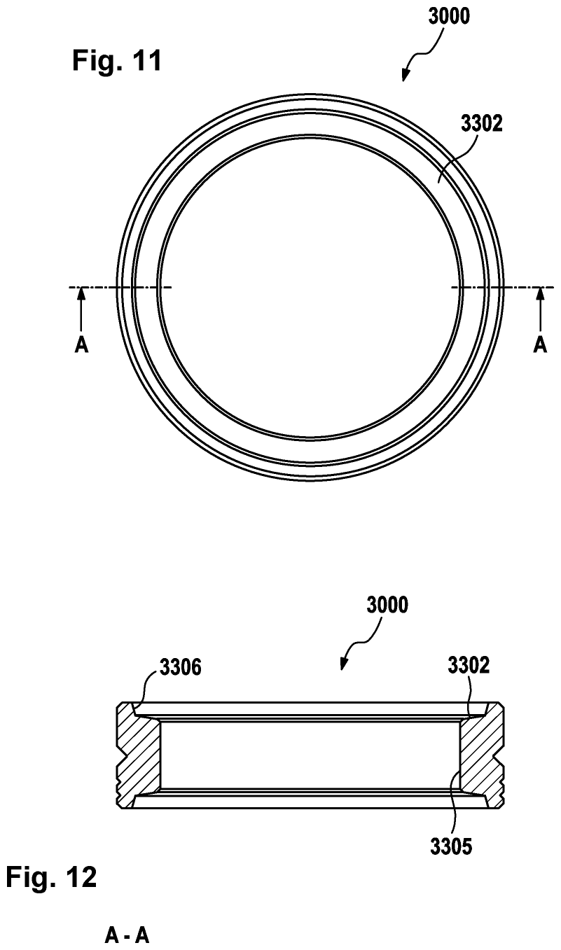

FIG. 11 shows a transport element 3000 which is designed in an alternative manner to the transport element 300 and is shown in FIG. 12 in a cross-sectional view. Unless described otherwise, the transport element 3000 is designed to be similar or identical/analogous to the transport element 300. The transport element 3000 (likewise) comprises limiting surfaces 3305 and 3306. In addition, a support surface 3302 is provided, which, however, in a modification to the support surface 302, is designed to slant towards the midpoint of the transport element 3000. It is for example provided that the limiting surfaces 3305 and 3306 have enough play relative to the headlight lens 202, wherefor examplely precise orientation is achieved by the slope of the support surface 3302. Moreover, the transport element 3000 is handled in an analogous manner to the following description of the handling of the transport element 300. The angle of the slant or slope of the support surface 3302 relative to the orthogonal of the rotational axis or when used as intended relative to the support plane is between 5° and 20°, and in the embodiment shown is 10°.

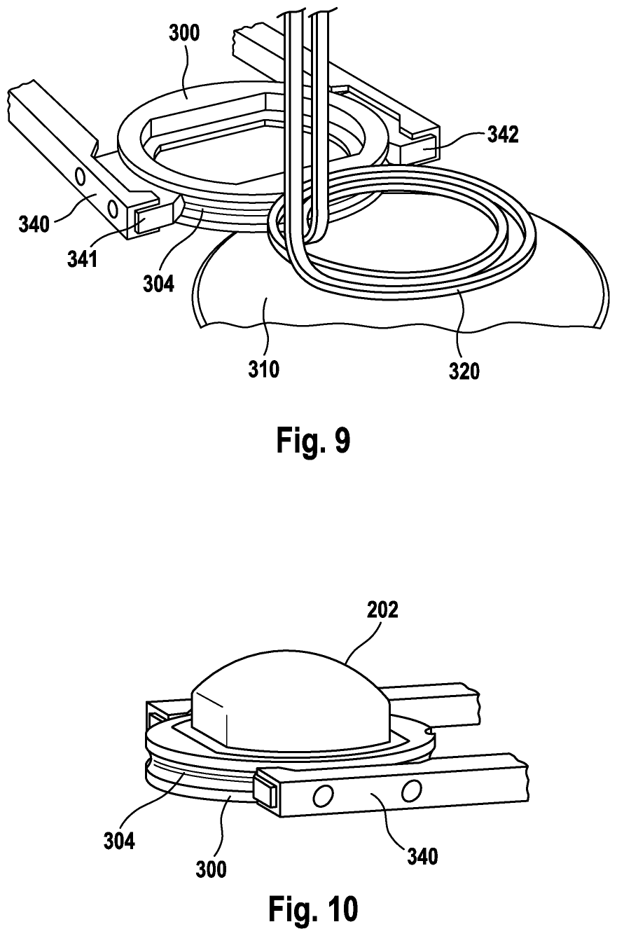

In addition, before placing the headlight lens 202 on the transport element 300, the transport element 300 is heated such that the temperature of the transport element 300 is approximately +−50 K the temperature of the headlight lens 202 or the edge 206. For example, the heating is carried out in a heating station 44 by means of an induction coil 320, as shown in FIGS. 8 and 9. In these figures, the transport element 300 is placed on a support 310 and for example is heated by means of the induction coil/induction heater 320 at a heating rate of 30-50 K/s, for example in less than 10 seconds. The transport element 300 is then grasped by a gripper 340, as shown in FIGS. 9 and 10. For this purpose, the transport element 300 for example also has an indentation 304 on its outer edge, which is designed to be circumferential in an embodiment. For correct orientation, the transport element 300 comprises a marker slot 303. The transport element 300 is guided to the press 8 by means of the gripper 340 and, as shown in FIG. 10, the headlight lens 202 is transferred from the press 8 to the transport element 300 and placed thereon.

In a suitable configuration, it is provided that the support 310 is designed as a rotatable plate. The transport element 300 is thus placed on the support 310 designed as a rotatable plate by hydraulic and automated movement units (e.g. by means of the gripper 340).

Centering is then carried out by two centering jaws 341 and 342 of the gripper 340 and specifically such that the transport elements are oriented in a defined manner by means of the marker slot 303, which is or can be detected by means of a position sensor. Once this transport element 300 has reached its linear end position, the support 340 designed as a rotatable plate begins to rotate until a position sensor has detected the marker slot 303.

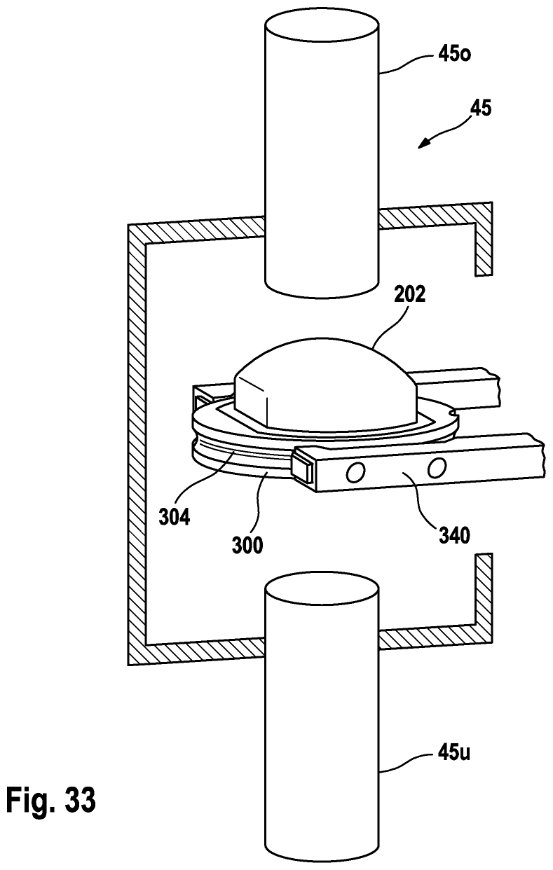

In a process step 126, an optical element or the headlight lens 202 is moved through a surface-treatment station 45 according to FIG. 33 on the transport element 300. In this figure, the optically effective surface 204 of the headlight lens 202 is sprayed with surface-treatment agent by means of a dual-substance nozzle 45o and at least one optically effective surface of the optical element, such as the optically effective surface 205 of the headlight lens 202, is sprayed with surface-treatment agent by means of a dual-substance nozzle 45u. The spraying process lasts no longer than 12 seconds, for example no longer than 8 seconds, for example no less than 2 seconds. The dual-substance nozzles 45o and 45u each comprise an inlet for atomizing air and an inlet for liquid, in which the surface-treatment agent is supplied, which is converted into a fog or spray by means of the atomizing air and exits through a nozzle. In order to control the dual-substance nozzles 45o and 45u, a control air port is also provided, which is actuated by means of the controller 15.

By means of the proposed method for producing an optical element or a headlight lens, a weathering resistance or hydrolytic resistance comparable to borosilicate glass is achieved. In addition, the costs for the manufacturing process increase only slightly compared to the manufacturing process of optical elements or headlight lenses with a weathering resistance or hydrolytic resistance corresponding to soda-lime glass.

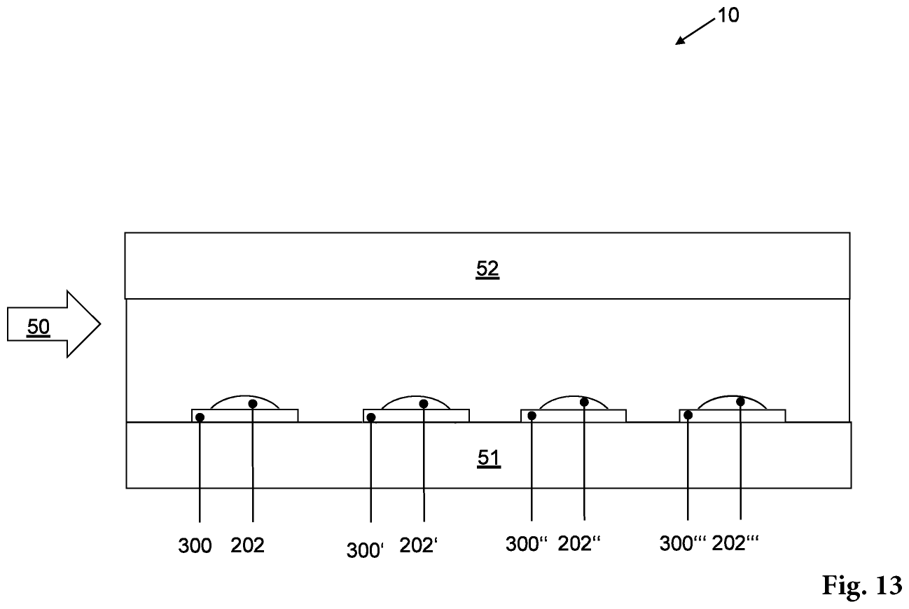

The transport element 300 together with the headlight lens 202 is then placed on the cooling path 10. In a process step 127, the headlight lens 202 is cooled by means of the cooling path 10. FIG. 13 is a detailed schematic view of the exemplary cooling path 10 from FIG. 1. The cooling path 10 comprises a tunnel which is or can be heated by means of a heating apparatus 52 and through which the headlight lenses 202, 202′, 202″, 202′″ are moved slowly on transport elements 300, 300′, 300″, 300′″ in the movement direction indicated by an arrow 50. In this process, the heating power decreases in the movement direction of the transport elements 300, 300′, 300″, 300′″ together with the headlight lenses 202, 202′, 202″, 202′″. For moving the transport elements 300, 300′, 300″, 300′″ together with the headlight lenses 202, 202′, 202″, 202′″, a conveyor belt 51 is e.g. provided, for example made up of chain members or implemented as a series of rollers.

At the end of the cooling path 10, a removal station 11 is provided, which removes the transport element 300 together with the headlight lens 202 from the cooling path 10. In addition, the removal station 11 separates the transport element 300 and the headlight lens 202 and transfers the transport element 300 to a return transport apparatus 43. From the return transport apparatus 43, the transport element 300 is transferred by means of the transfer station 9 to the heating station 44, in which the transport element 300 is placed on the support 310 designed as a rotatable plate and is heated by means of the induction heating 320.

A process step 128 lastly follows, in which residues of the surface-treatment agent on the lens are washed away in a washing station 46.

It is for example provided that the optical element or lens has a transmission of greater than 90% after washing.

It may be provided that, with reference to the heating of a flat gob, microlens arrays are pressed, which are not used as an array, but instead their individual lenses are used. An array of this kind is for example shown in FIG. 54, which shows a large number of individual lenses T50 on an array T51, which have been generated by pressing. In such a case, it is provided that the individual lenses T50 of the array T51 are separated.

The device shown in FIG. 1 also comprises a controller 15 for controlling and/or regulating the device 1 shown in FIG. 1. The device 1A shown in FIG. 1A also comprises a controller 15A for controlling and/or regulating the device 1A shown in FIG. 1A. The device 1B shown in FIG. 1B also comprises a controller 15B for controlling and/or regulating the device 1B shown in FIG. 1B. The controller 15, 15A and 15B for example ensure that the individual process steps are continuously interlinked.

The elements in FIG. 1, FIG. 1A, FIG. 1B, FIG. 5, FIG. 6, FIG. 13, FIG. 24, FIG. 27, FIG. 28, FIG. 29, FIG. 30, FIG. 32, FIG. 33, FIG. 34, FIG. 38, FIG. 39, FIG. 42, FIG. 43, FIG. 44 and FIG. 45, FIG. 46, FIG. 47, FIG. 52, FIG. 53 and FIG. 54 are drawn with simplicity and clarity in mind and not necessarily to scale. For example, the scales of some elements are exaggerated relative to other elements to enhance understanding of embodiments of the present disclosure.

The claimed or disclosed method makes it possible to expand the range of applications for press molded lenses, for example, with respect to lenses, projection displays, microlens arrays and/or, for example, adaptive vehicle headlights.

### LIST OF REFERENCE SIGNS

1, 1A, 1B device
2 melting unit
2B adjustable outlet
3 preform device
4, 4A, 4B transfer station
5A, 5B, 5 cooling apparatus
6A, 6B, 6C heating apparatus
7 transfer station
8 press
9 transfer station
10 cooling path
11 removal station
15, 15A, 15B controller
20 motor vehicle
41 transport apparatus
42 transport apparatus
43 return transport apparatus
44 heating station
45 surface treatment station
45o two-substance nozzle
45u two-substance nozzle
46 washing station
50 arrow
51 conveyor belt
52 heating apparatus
120 process step
121 process step
122, 122′ process step
123, 123′ process step
124, 124′ process step
125 process step
126 process step
127 process step
128 process step
130 preform
131 temperature gradient
132 temperature gradient
201, 201′, 201″ motor vehicle headlights
202 headlight lens
203 lens body
204 substantially convex (for example optically effective) surface
205 substantially planar (for example optically effective) surface
206 lens edge
210 light source
212 reflector
214 shield
215 edge
220 bright-dark-boundary
230 optical axis from 202
260 step from 206
261 surface of the lens edge 206
300, 3000 transport element
302, 3302 support surface
303 marker slot
304 indentation
305, 3305 limitation surface
306, 3306 limitation surface
310 support
320 induction coil/induction heating
340 gripper
341, 342 centering jaws
400, 500 support devices
401, 501 carrier body
402, 502 support surface
403, 503 base surface
411, 511 flow channels
412, 512 flow channels
421, 521 metallic filler material
422, 522 metallic filler material
800 pressing station
801 lower pressing unit
802 upper pressing unit
811, 812, 814, 815 rod
816 upper connecting part
817 lower plate
821 plate
822 lower mold
823 upper mold
840 press drive
841, 842, 843 rods
850 press drive
851, 852, 853 guide rod
H851, H852, H853 sleeves
L851, L853 bearing
855 plate
870 movement mechanism
872 induction loop
879 induction heater
4001 gob
4002 nut
5000 hood-type annealing furnace
5001 heating coil
5002, 5202, 5302 protective cover
5112, 5212, 5312 cylindrical region
5132 rounded region
5122, 5222, 5322 covering region
5242, 5342 conical region
5232, 5332 curvature
DA diameter from 204
DB diameter from 205
DBq orthogonal diameter to DB
DL diameter from 202
DLq orthogonal diameter to DL
F2 surround sensor system
F3 controller
F4 illumination device
F5 objective
F20, F201 vehicle headlights
F41 light source assembly
F42 front optics
F421 light exit area of F4
L4 light
L41 light irradiated in F42
L5 illumination pattern
V1 front optics array
V2 secondary lens
V11, V12, V13, V14, V15 front optics
V20 base part
V21 surface from V20
V111, V121, V131,
V141, V151 light entrance area
V115, V125, V135,
V145, V155 side surfaces
V2011, V2012, V2013,
V2014, V2015 lenses
V11
VL light source assembly
M2 surround sensor system
M3 controller
M4 light emission unit
ML4 light
M5 concave lens
ML5 further formed light
M6 projection optics
ML6 resulting light distribution
G20, M20 headlights
G2 surround sensor system
G3 controller
G4 controller
G5 illumination device
GL5 light generated by GL5
G6 system of micromirrors
GL6 illumination pattern
G7 projection optics
GL7 light
Pₘₐₓ, Pₘᵢₙ light output
PS press station
PO upper pressing unit
PU lower pressing unit
OF upper mold
UF lower mold
U10, O10 actuator
U11, U12 movable connector
U51, U52 movable guide rods
UO fixed guide element
O11 actuator-side fixed connector
O12 movable guide element
O14 mold-side fixed connector
O51, O52 fixed guide rods
P811, P812 reinforcement profile
SP811, SP812,
SP814, SP815 clamps
ΔKIPOF, ΔKIPUF maximum tilt
ACHSOF, ACHSUF actual pressing direction
ACHSOF*, ACHSUF* target pressing direction
ΔVEROF, ΔVERUF
ENTR ring
ENTS1, ENTS2 discs
BALG bellow
T1 preform
T2, T3 clamping devices
T4 clamping assembly

1-24. (canceled)

25. A method for producing a headlight lens, the method comprising:
providing a first mold;
providing at least one second mold;
providing a surface-treatment agent which comprises a solvent and a solid dissolved in the solvent;
providing a gas;
heating a blank made of soda-lime glass;
press-molding the heated blank to form the headlight lens having at least one first optically effective surface using the first mold and the at least one second mold;
generating a spray by thoroughly mixing the surface-treatment agent with the gas;
exposing the at least one first optically effective surface to the spray which promotes crosslinking of oxygen ions with silicon ions on the at least one first optically effective surface; and
cooling the headlight lens with addition of heat.

26. The method according to claim 25, wherein the solid comprises an amount of one solid from the group consisting of sodium and phosphate.

27. The method according to claim 25, wherein the solid comprises phosphate.

28. The method according to claim 25, wherein the temperature of the at least one first optically effective surface during exposing with surface-treatment agent is no greater than TG+150 K, wherein TG denotes the glass transition temperature of the soda-lime glass.

29. The method according to claim 28, wherein the surface-treatment agent forms droplets in the spray, of which the average diameter is no greater than 50 μm.

30. The method according to claim 29, wherein the surface-treatment agent forms droplets in the spray, of which the average diameter is no less than 10 μm.

31. The method according to claim 26, wherein the amount of the crosslinking of oxygen ions to silicon ions on the at least one first optically effective surface after spraying is represented by:
$$\frac{Q ( 4 )}{Q ( 4 ) + Q ( 3 )} \geq 0.9$$
wherein Q(3) denotes 3 oxygen ions crosslinking at tetrahedron corners of a silicon ion and Q(4) denotes 4 oxygen ions crosslinking at tetrahedron corners of a silicon ion.

32. The method according to claim 31, wherein the amount of the crosslinking of oxygen ions to silicon ions at a depth of at least 5 μm below the at least one first optically effective surface after spraying is represented by:
$$\frac{Q ( 4 )}{Q ( 4 ) + Q ( 3 )} \leq 0.5$$

33. The method according to claim 31, wherein the amount of the crosslinking of oxygen ions to silicon ions at a depth of at least 5 μm below the at least one first optically effective surface after spraying is represented by:
$$\frac{Q ( 4 )}{Q ( 4 ) + Q ( 3 )} \leq 0.25$$

34. The method according to claim 32, wherein the solid comprises an amount of one solid from the group consisting of sodium phosphate and potassium phosphate.

35. The method according to claim 33, wherein the solid comprises an amount of one solid from the group consisting of sodium phosphate and potassium phosphate.

36. The method according to claim 33, wherein the solid comprises aluminum.

37. A method for producing a headlight lens, the method comprising:
providing a first mold;
providing at least one second mold;
heating a blank made of soda-lime glass;
press-molding the heated blank to form the headlight lens having at least one first optically effective surface using the first mold and the at least one second mold;
spraying the at least one first optically effective surface with a surface-treatment agent which promotes crosslinking of oxygen ions with silicon ions on the at least one first optically effective surface, wherein the surface-treatment agent comprises a solvent and a solid dissolved in the solvent; and
cooling the headlight lens with addition of heat.

38. The method according to claim 37, wherein the amount of the crosslinking of oxygen ions to silicon ions on the at least one first optically effective surface after spraying is represented by
$$\frac{Q ( 4 )}{Q ( 4 ) + Q ( 3 )} \geq 0.9$$
wherein Q(3) denotes 3 oxygen ions crosslinking at tetrahedron corners of a silicon ion and Q(4) denotes 4 oxygen ions crosslinking at tetrahedron corners of a silicon ion.

39. The method according to claim 38, wherein the amount of the crosslinking of oxygen ions to silicon ions on the at least one first optically effective surface after spraying is represented by:
$$\frac{Q ( 4 )}{Q ( 4 ) + Q ( 3 )} \geq 0.95$$

40. The method according to claim 38, wherein the amount of the crosslinking of oxygen ions to silicon ions at a depth of at least 5 μm below the at least one first optically effective surface after spraying is represented by:
$$\frac{Q ( 4 )}{Q ( 4 ) + Q ( 3 )} \leq 0.5$$

41. The method according to claim 38, wherein the amount of the crosslinking of oxygen ions to silicon ions at a depth of at least 5 μm below the at least one first optically effective surface after spraying is represented by:
$$\frac{Q ( 4 )}{Q ( 4 ) + Q ( 3 )} \leq 0.25$$

42. The method according to claim 37, wherein the temperature of the at least one first optically effective surface during exposing with surface-treatment agent is no greater than TG+150 K, wherein T_{G} denotes the glass transition temperature of the soda-lime glass.

43. The method according to claim 38, wherein the temperature of the at least one first optically effective surface during exposing with surface-treatment agent is no greater than T_{G}+150 K, wherein T_{G} denotes the glass transition temperature of the soda-lime glass.

44. The method according to claim 40, wherein the temperature of the at least one first optically effective surface during exposing with surface-treatment agent is no greater than T_{G}+150 K, wherein T_{G} denotes the glass transition temperature of the soda-lime glass.
